(19) United States
(12) Patent Application Publication
(10) Pub. No.: US 2022/0117453 A1
(43) Pub. Date: Apr. 21, 2022

(54) SUCTION APPARATUS AND METHOD FOR CLEANING A FILTER

(71) Applicant: Alfred Kärcher SE & Co. KG, Winnenden (DE)

(72) Inventor: Felix TREITZ, Berglen (DE)

(21) Appl. No.: 17/566,245

(22) Filed: Dec. 30, 2021

Related U.S. Application Data
(63) Continuation of application No. PCT/EP2020/066794, filed on Jun. 17, 2020.

(30) Foreign Application Priority Data
Jul. 3, 2019 (DE) 10 2019 117 920.3

(51) Int. Cl. A47L 9/20; A47L 5/36; A47L 9/12; B01D 46/71; B01D 46/42; B01D 46/52; B01D 46/10; F16K 1/12; F16K 1/36; F16K 31/06

(52) U.S. Cl. CPC A47L 9/20; A47L 5/365; A47L 9/122; B01D 46/71; B01D 46/4272; B01D 2279/55; B01D 46/10; F16K 1/12; F16K 1/36; F16K 31/0655; B01D 2271/02; B01D 46/521

(57) ABSTRACT

A suction apparatus is provided including a suction unit for creating a suction flow, at least one filter and a filter cleaning device, wherein the filter cleaning device includes at least one valve having a closing body and a counter device, and wherein in an open position of the valve the filter has a filter cleaning flow applied thereto and wherein in a closed position of the valve the filter cleaning flow is or becomes inactive, wherein the closing body has a first contact region and a second contact region, wherein, in the closed position of the valve, both the first contact region and the second contact region are in contact against the counter device, and wherein in the open position of the valve, a flushing air flow flows past both the first contact region and the second contact region to the filter.

### CROSS REFERENCE TO RELATED APPLICATIONS

This application is a continuation of international application number PCT/EP2020/066794, filed on Jun. 17, 2020, which claims the benefit of German patent application No. 10 2019 117 920.3, filed on Jul. 3, 2019, which are incorporated herein by reference in their entirety and for all purposes.

### BACKGROUND OF THE INVENTION

The invention relates to a suction apparatus, comprising a suction unit for creating a suction flow, at least one filter and a filter cleaning device, wherein the filter cleaning device comprises at least one valve having a movable closing body and a counter device for the closing body, and wherein in an open position of the at least one valve the at least one filter has a filter cleaning flow applied thereto and wherein in a closed position of the at least one valve the filter cleaning flow is or becomes inactive.

The invention further relates to a method for cleaning a filter.

U.S. Pat. No. 4,329,161 discloses a vacuum cleaner having valve system for creating pulses of air through a filter element.

DE 20 2006 020 948 U1 discloses a suction cleaning device having a closing valve for cleaning a filter.

DE 10 2015 100 426 A1 discloses a cleaning device having a perforated plate resonator which is associated with a noise source and is operatively connected to the noise source for sound communication therewith.

EP 2 451 332 B1 relates to a suction apparatus for cleaning purposes, which suction apparatus comprises a valve device having a valve seat forming an external air inlet and comprising a valve body which is movable relative to said valve seat and which, when in a closed position, is in sealing contact against the valve seat and, when in an open position, releases the valve seat. The suction apparatus comprises an energy storage device to which energy that is to be stored can be supplied by actuation of an actuating member and from which stored energy can be released for transferring the valve body from a closed position to an open position. The energy storage device comprises at least one elastically deformable energy storage member, wherein the at least one energy storage member is configured in the form of a spring.

DE 10 2010 029 518 A1 discloses a vacuum cleaner comprising a dirt collection container, which dirt collection container has a suction inlet and is in flow communication with a suction unit via at least one filter and a suction conduit, and comprising a flushing air supply device for supplying flushing air into the suction conduit downstream of the filter, wherein the flushing air supply device has at least one flushing air opening and a sleeve-shaped closing body which, when in a closed position, prevents flushing air from entering the suction conduit through the at least one flushing air opening and which can be moved manually in a direction of movement into a release position which releases the ingress of flushing air into the suction conduit through the at least one flushing air opening. The closing body is open at its two end faces and, in its closed position, prevents flushing air from entering the suction conduit through the at least one flushing air opening by virtue of at least two interacting sealing elements which can be offset relative to one another in the direction of movement.

DE 10 2010 029 524 A1 discloses a vacuum cleaner comprising a dirt collection container, which dirt collection container has a suction inlet and is in flow communication with a suction unit via at least one filter and a suction conduit, and comprising a flushing air supply device for supplying flushing air into the suction conduit downstream of the filter, wherein the flushing air supply device has at least one flushing air opening, and a closing body having a front face facing towards the suction conduit and a rear face facing away from the suction conduit, which closing body can be moved back and forth between a closed position, in which it closes off the flushing air opening, and a release position, in which it releases the flushing air opening. The closing body can be moved into its release position against a restoring force by having a negative pressure applied to the rear face thereof.

EP 2 672 871 B1 discloses a vacuum cleaner having a battery device for supplying energy to an external air valve device. A control device is provided which controls the cleaning of a filter device by way of the external air valve device, wherein triggering the filter cleaning is accomplished manually or automatically, and wherein the control device controls an electric motor device of a suction unit.

WO 2014/173481 A1 discloses a dirt suction device having a filter cleaning control for a filter.

DE 10 2011 015 074 A1 discloses a suction apparatus having a suction motor which is associated with a motor sensor. The motor sensor is used to generate a suction motor sensor signal. A control device is provided for controlling a filter cleaning device for carrying out a cleaning process on a filter depending on the suction motor sensor signal.

DE 10 2016 125 385 A1 discloses a vacuum cleaner.

EP 3 120 744 B1 discloses an apparatus for controlling cleaning of a filter unit for vacuum cleaners.

DE 10 2013 108 559 A1 discloses a method for operating a vacuum cleaner for back-cleaning a filter element comprised by the vacuum cleaner.

DE 20 2010 012 821 U1 discloses filter cleaning for dirt suction devices using an external fan.

DE 101 01 219 C9 discloses a dirt suction device.

US 2005/0011036 A1 discloses a vacuum cleaner.

DE 10 2005 017 702 A1 discloses a method for cleaning the filters of a vacuum cleaner.

EP 2 347 690 B1 discloses a suction cleaning apparatus.

CN 101484060 B likewise discloses a vacuum cleaner.

### SUMMARY OF THE INVENTION

In accordance with an exemplary embodiment of the invention, there is provided a suction apparatus which enables effective cleaning of the at least one filter to be achieved.

In accordance with an exemplary embodiment of the invention, the suction apparatus comprises a suction unit for creating a suction flow, at least one filter and a filter cleaning device, wherein the filter cleaning device comprises at least one valve having a movable closing body and a counter device for the closing body, and wherein in an open position of the at least one valve the at least one filter has a cleaning flow applied thereto and wherein in a closed position of the at least one valve the cleaning flow is or becomes inactive, wherein the closing body has at least a first contact region with the counter device and a second contact region with the counter device, wherein the second contact region is in spaced-apart relation to the first contact region in a height direction, wherein, in the closed position of the at least one valve, both the first contact region and the second contact region are in contact against the counter device, and wherein in the open position of the at least one valve, both the first contact region and the second contact region are in spaced-apart relation to the counter device, wherein, in the open position of the at least one valve, a flushing air flow flows past both the first contact region and the second contact region to the at least one filter.

By virtue of the closing body having (at least) a first contact region and a second contact region in offset relation to the first contact region, it is possible, in the closed position of the at least one valve, to establish a seal against the counter device over (at least) two levels. When the valve is opened, a flow of flushing air can then be admitted at (at least) two separate levels to the at least one filter.

The open position of the at least one valve is to be taken to mean all positions in which the closing body is unseated from the counter device. Here, the open position can be a plurality of positions, i.e., it need not be a single position.

The plurality of delivery regions enable a quick opening action of the at least one valve. This in turn makes for good filter cleaning results for the at least one filter. The effect can be achieved that a large volume flow of a flushing flow (external air flow) is present at the at least one filter within a short time period. It has been found that a time course of a volume of backflushing air across the at least one filter (which results in the filter cleaning flow) is steep.

Furthermore, there quickly results a high level for an amount of flushing air (an amount of filter cleaning air) that acts upon the at least one filter.

Thus, in particular, even in a scenario where a lower-power suction fan is used, such as for example in a suction apparatus that is operated on battery power, an optimized filter cleaning result can be achieved for the at least one filter. Sustained, constant suction performance can thereby be realized.

In the solution in accordance with the invention, upon opening of the valve, partial flows of flushing air can be achieved at the at least one valve. In particular, a partial flow can flow past the closing body to the at least one filter and a partial flow can flow through the closing body to the at least one filter. By virtue of the two contact regions, offset in height, at least two gaps, particularly in the form of annular gaps of relatively large diameter, can be quickly opened upon opening of the at least one valve. The effect can be achieved that an opening cross-sectional area increases with valve stroke. This also contributes to achieving an optimized filter cleaning result.

It is also possible for the first contact region and the second contact region to have different configurations with respect to a pressure-effective area thereof. For example, depending on how the contact regions are configured, the effect can be achieved that, in the closed position of the at least one valve, a pressure difference between a negative pressure region and a normal pressure region holds the closing body in the closed position, or it can be achieved that the pressure difference seeks to urge the closing body of the at least one valve from the closed position to the open position. This also contributes to achieving a quick opening action of the at least one valve while exhibiting a large cross-sectional air flow area.

Furthermore, in the solution in accordance with the invention, it has been found that a popping noise generated by the opening of the at least one valve is reduced.

The suction apparatus in accordance with the invention can find application for example in a vacuum cleaner configured in the form of a stand-alone apparatus. It can, for example, also be integrated in a machine that has further functions in addition to those of the suction apparatus, as is, for example, a travelling floor cleaning machine (such as a sweeper). It can also be implemented in a suction robot, for example. A suction apparatus in accordance with the invention can also be integrated in a built-in suction system, for example.

In particular, provision is made for a distance between the first contact region and the second contact region in the height direction to be at least 6 mm and preferably at least 10 mm.

A stroke of movement of the closing body, which is a linear stroke in particular, is in particular at least 5 mm. Preferably, this stroke of movement is no more than 50 mm.

In particular, a negative pressure region is provided in a suction mode of operation, at which negative pressure region the at least one filter is arranged, and a normal pressure region is provided, at which normal pressure region the counter device is arranged, wherein in the closed position of the at least one valve the normal pressure region is in fluid-tight isolation from the negative pressure region, and in the open position of the at least one valve the normal pressure region and the negative pressure region are operatively connected for fluid communication with each other by a channel device. In a “normal operation” of the suction apparatus, without the at least one valve being active for cleaning the at least one filter, the normal pressure region is in fluid-tight isolation from the negative pressure region. Upon activation of the at least one valve for performing a cleaning operation on the at least one filter, the closing body is unseated from the counter device. As a result of the pressure difference between the normal pressure region and the negative pressure region, a flushing air flow is created which is used to clean the at least one filter. The normal pressure region is a region upon which the suction unit does not act in its application of negative pressure. The normal pressure region is, for example, at atmospheric pressure. However, provision may be made for the pressure in the normal pressure region to be at a pressure above atmospheric. By way of example, in an exemplary embodiment of a sweeping machine, provision is made for a compressor to generate a pressure above atmospheric pressure in the normal pressure region.

In particular, the filter cleaning flow is created or becomes created by bringing the at least one valve from the closed position to the open position. Thus, by opening of the valve, a corresponding filter cleaning flow can be created “automatically” in that external air is allowed to enter and act on the at least one filter.

It is particularly advantageous for the channel device at its input side to open to the normal pressure region and at its output side to open to the negative pressure region. This provides a simple way of creating a filter cleaning flow for application to the at least one filter.

It is particularly advantageous for an inlet cross-section for air into the channel device, which inlet cross-section is in particular present at a gap, and preferably at an annular gap, to increase continuously with valve stroke when the closing body is unseated from the counter device. The valve can thereby be quickly opened and a relatively large volume flow can be quickly provided to the at least one filter for cleaning the latter.

In an embodiment, provision is made for the filter cleaning flow to be created or to become created while the at least one filter has a suction flow applied thereto by the suction unit. Cleaning of the at least one filter can thereby, in a sense, be executed while the suction apparatus is running. Among other things, this makes for a simple control of a filter cleaning operation.

In particular, at least one of the following is provided:
the height direction is parallel to a direction of movement, and in particular to a direction of displacement, of the closing body;
the height direction is parallel to a principal direction of flow of a suction flow when the latter flows through the at least one filter in a suction mode of operation;
the height direction is parallel to a principal direction of flow of the filter cleaning flow when the latter flows through the at least one filter;
the height direction is transverse, and in particular perpendicular, to an envelope surface of the at least one filter at a clean side thereof;
the height direction is parallel to an axis of symmetry of the at least one valve.

By corresponding orientation of the height direction, the filter cleaning device can be built and integrated in the suction apparatus in a compact form. A quick opening action of the at least one valve can be achieved.

Preferably, the counter device has a first counter contact region for the first contact region and has a second counter contact region for the second contact region, wherein the second counter contact region and the first counter contact region are in spaced-apart relation in the height direction. This provides a simple way for the closing body, in the closed position of the at least one valve, to be placed in contact against the counter device via at least two contact regions that are offset in height from each other. In particular, the first counter contact region and the second counter contact region are spaced-apart, in the height direction, by a distance of at least 6 mm, and preferably of at least 10 mm. Advantageously, here, the counter device is configured such that, when the at least one valve transitions from the closed position to the open position, the first contact region and the second contact region are unseated from the counter device at least approximately at the same time. Correspondingly, it is preferably provided for the first contact region and the second contact region to be placed in contact against the counter device at least approximately at the same time when the closing body transitions from the open position to the closed position.

In order to achieve fluid tightness at the contact regions, provision is made for the first contact region and the second contact region in each case to be associated with a sealing device, in particular in the form of a sealing ring, in particular wherein the sealing device is arranged at the closing body and/or the sealing device is arranged at the counter device. The sealing device provides fluid-tight sealing. It contacts the closing body and the counter device.

It is advantageous for the counter device to comprise a housing in which the closing body is movably arranged and which has a throughflow space for flushing air. The housing can be utilized to arrange the at least one valve in a protected manner. Furthermore, the housing can be utilized for flow routing purposes.

It is advantageous for a clean side of the at least one filter to be located at a negative pressure chamber, in particular with at least one of the following:
the negative pressure chamber is connected to the suction unit;
in a suction mode operation of the suction apparatus, the negative pressure chamber is permanently and operatively connected to the suction unit for fluid communication therewith;
at least one channel of the filter cleaning device opens to the negative pressure chamber for supplying air to the at least one filter when in a filter cleaning mode of operation;
the counter device is arranged at the negative pressure chamber;
the at least one valve provides fluid-tight isolation of the negative pressure chamber from a normal pressure region when the at least one valve is in a closed position.

Simple flow routing results if a clean side of the at least one filter is located at a negative pressure chamber. The negative pressure chamber can be fluid-tightly sealed against a normal pressure region of the suction apparatus in a simple manner by way of the at least one valve. By the connection of the negative pressure chamber to the suction unit and in particular by a permanent operative connection and fluid communication (when in a suction mode of operation), a suction flow can be passed through the at least one filter in a simple manner, in particular in order to apply the suction flow to a suction container, a suction port and, for example, a suction hose or a suction tube. One or more channels of the filter cleaning device which open to the negative pressure chamber can be utilized to provide flushing air for cleaning the at least one filter.

Positioning the counter device at the negative pressure chamber makes for a compact construction of the suction apparatus having the filter cleaning device.

It is advantageous for the at least one valve and/or the closing body to be of rotationally symmetric configuration relative to the axis of symmetry, in particular wherein the axis of symmetry is parallel to the height direction. This results in optimized supply of air to the at least one filter in order to achieve effective filter cleaning.

In accordance with an exemplary embodiment of the invention, the closing body and the counter device are configured to conform to one another such that, in the open position of the at least one valve, a plurality of separate partial air flows flow at the filter cleaning device, and in particular a first partial flow flows externally past the closing body and a second partial flow flows through the closing body, to the at least one filter. This provides a simply way of achieving a quick opening action of the at least one valve. The at least one filter can have large volume flow applied thereto in a filter cleaning operation.

In accordance with an exemplary embodiment of the invention, the filter cleaning device, in the open position of the at least one valve, has at least a first channel for a first partial flow and a second channel for a second partial flow, wherein the second channel is separate from the first channel. A quick opening action of the at least one valve can thereby be achieved. The at least one filter can have a high volume flow of flushing air applied thereto in a filter cleaning operation.

In particular, at least one of the following is provided:
the first channel at its input side opens to a normal pressure region;
the second channel at its input side opens to the normal pressure region;
the first channel at its output side opens to a negative pressure region;
the second channel at its output side opens to the negative pressure region;
the first channel at its input side is closed to the normal pressure region when the at least one valve is in the closed position;
the first channel at its input side is open to the normal pressure region when the at least one valve is in the open position;
the first channel at its output side is in permanent operative connection to the negative pressure region for fluid communication therewith;
the second channel at its output side is closed to the negative pressure region when the at least one valve is in the closed position;
the second channel at its output side is open to the negative pressure region when the at least one valve is in the open position;
the second channel at its input side is in permanent operative connection to the normal pressure region for fluid communication therewith.

This provides a simple way of achieving, by unseating the closing body from the counter device, that flushing air is supplied to the at least one filter via both the first channel and the second channel. A quick opening action of the at least one valve can be achieved and the at least one filter can have a high volume flow of flushing air applied thereto for its cleaning.

It is particularly advantageous for the first channel, in at least a portion thereof, to extend through the closing body and, in particular, for the first channel, in at least a portion thereof, to be bounded by an inner wall of the closing body. In this manner, a quick opening action of the at least one valve can be achieved. The at least one filter can have a high volume flow of flushing air applied thereto within a relatively short time period, for cleaning the at least one filter.

It is further advantageous for the first channel and/or the second channel, in at least portions thereof, to extend along a lateral outer contour of the closing body, and, in particular, for a lateral outer wall of the closing body to bound the first channel and/or the second channel. Thus, an additional fluid pathway can be provided in order to achieve effective cleaning of the at least one filter when the at least one valve is open.

It is further advantageous for the first channel and/or the second channel to have at least one first region and at least one second region, wherein the at least one first region is oriented transversely to the height direction and the at least one second region is oriented at least approximately parallel to the height direction and wherein, in a filter cleaning mode of operation, a principal direction of flow in the at least one first region is oriented transversely to the height direction and is, in particular, oriented radially, and wherein in the at least one second region, a principal direction of flow in the filter cleaning mode of operation is oriented at least approximately parallel to the height direction and is, in particular, oriented axially. Thus, the valve can be quickly opened. A relatively high volume flow can be quickly provided to the at least one filter for cleaning the latter.

It is then advantageous for the first channel and/or the second channel to have a region of directional change for changing a direction of flow. Thus, the at least one filter can be effectively supplied with flushing air for purposes of cleaning the at least one filter.

In particular, at least one of the following is provided:
at least one inlet of the first channel is arranged at a first region of the first channel;
at least one outlet of the first channel is arranged at a second region of the first channel;
at least one inlet of the second channel is arranged at a first region of the second channel;
at least one outlet of the second channel is arranged at a second region of the second channel.

In this way, effective flow routing can be achieved with compact construction of the filter cleaning device. The at least one valve can be quickly opened and a high volume flow can be provided to the at least one filter for its cleaning.

In an embodiment, the first channel and/or the second channel have first regions spaced-apart in the height direction and with a second region interposed therebetween. This makes for optimized flow routing along with directional change in order to provide to the at least one filter a high volume flow of flushing air for its cleaning.

In particular, at least one of the following is provided:
in the open position of the at least one valve, a first region of the first channel is formed between a top side of the closing body and the counter device;
a second region of the first channel is formed in the closing body;
in the open position of the at least one valve, one or more first regions of the second channel and/or of the first channel and/or one or more second regions of the second channel and/or of the first channel are formed between the counter device and the closing body;
in the open position of the at least one valve, a first region of the second channel is formed between a bottom side of the closing body and the counter device.

This makes for optimized flow routing. The effect can be achieved that, with the at least one valve in the open position, the at least one filter is supplied with flushing air taking a path both through the closing body and past the closing body. The at least one valve can be quickly opened with relatively low noise emission and the at least one filter can have provided thereto a relatively large volume flow for cleaning the at least one filter.

In an embodiment, at least one of the following is provided:
the first channel has at least a first inlet and a second inlet spaced-apart from the first inlet;
the first channel is T-shaped in cross-section in at least a portion thereof;
the first channel has a transverse region at which the first inlet and the second inlet are arranged, wherein arranged at the transverse region is a collection region and wherein starting from the first inlet a first partial flow flows to the collection region and wherein starting from the second inlet a second partial flow flows to the collection region;
the first channel has a collection region which combines partial flows, and a combined flow is passed through the closing body to the at least one filter.

Through the first inlet and the second inlet, flushing air can be incoupled at different positions for a partial flow. For example, a first partial flow is created which flows radially inwards, and a second partial flow is created which flows radially outwards. These partial flows are combined at the collection region and can then flow through the closing body. (There is additionally provided at least one further partial flow which flows past the closing body.) Thus, a large amount of flushing air can be provided to the at least one filter within a short time period in order to effect filter cleaning. The at least one valve can be quickly opened.

It is then advantageous for the first contact region and/or the second contact region to have a plurality of sub-contact regions, in particular with at least one of the following:
sub-contact regions of the associated first contact region are at the same height with respect to the height direction;
sub-contact regions of the second contact region are at the same height with respect to the height direction;
a first sub-contact region surrounds a second sub-contact region;
sub-contact regions are concentric to one another;
a channel passes through the closing body, between sub-contact regions.

In particular, this provides a way for the first channel to have a plurality of inlets, wherein these inlets are closed when the at least one valve is in the closed position.

In an embodiment, the closing body comprises a first disk element and a second disk element which is in spaced-apart relationship to the first disk element in the height direction, wherein the first contact region is arranged or formed at the first disk element and the second contact region is arranged or formed at the second disk element, and wherein a connection region is positioned between the first disk element and the second disk element. The first disk element and the second disk element provide a simple way of forming contact regions towards a top side and towards a bottom side. A wall of the counter device can be positioned between the first disk element and the second disk element in order to obtain optimized supply of flushing air to the at least one filter in a filter cleaning operation. The first disk element and/or the second disk element is/are of circular disk shape for example.

In particular, an outer contour of the connection region is set back in relation to a lateral end of the first disk element and the second disk element. A partial flow of flushing air can flow past the outer contour. By setting back the outer contour, a wall of the counter device can be, or become, positioned between the first disk element and the second disk element. The closing body can then be moved relative to the wall, in particular wherein contact (for example contact via the first contact region) can be established against said wall. This provides a simple way of opening both a first channel and a second channel for supplying flushing air to the at least one filter upon opening of the at least one valve.

For example, the closing body is C-shaped or U-shaped in cross-section at the connection region thereof. This provides a simple way of achieving a set back outer contour where, for example, a wall can be positioned between the first disk element and the second disk element.

It is particularly advantageous for the counter device to comprise a wall which projects into a space between the first disk element and the second disk element, in particular wherein, in the closed position of the at least one valve, the first contact region is in contact against the wall. A compact construction is thereby provided to the filter cleaning device. The possibility is afforded of opening at least two separate channels for two separate partial flows by unseating the closing body from the counter device. As a result, a quick opening action of the at least one valve is achieved.

In particular, provision is made for the first contact region and the second contact region to point in the same direction, relative to the height direction. This makes for a compact construction.

In an embodiment, the first contact region at the first disk element points in a direction away from the at least one filter and the second contact region at the second disk element points in a direction away from the at least one filter. In an alternative embodiment, the first contact region at the first disk element points in a direction towards the at least one filter and the second contact region at the second disk element also points in a direction towards the at least one filter.

It is particularly advantageous for the first disk element and the second disk element to have different diameters. Depending on whether the first disk element or the second disk element has a larger pressure-effective diameter, the closing body, as a result of a pressure difference between a negative pressure region and a normal pressure region, can be automatically unseated from the counter device, or the closing body, as a result of the pressure difference, can be “automatically” held to the counter device when the at least one valve is in the closed state.

It is advantageous for the counter device and the closing body to be configured to conform to each other such that when the at least one valve transitions from the closed position to the open position, the closing body moves in a direction of the at least one filter.

Alternatively, it is possible for the counter device and the closing body to be configured to conform to each other such that when the at least one valve transitions from the closed position to the open position, the closing body moves away from the at least one filter.

In an embodiment, the counter device has a first wall as a counter face for the first contact region and has a second wall, spaced apart in the height direction, as a counter face for the second contact region. This makes for a compact construction of the filter cleaning device.

In particular, an opening is arranged at the counter device, between the first wall and the second wall, which opening is operatively connected to a normal pressure region for fluid communication therewith, in particular wherein a normal for a mouth of the opening is oriented transversely to the height direction. This allows at least a first channel and a second channel to be opened when unseating the closing body from the counter device. As a result, the at least one valve can be quickly opened and the at least one filter can have applied thereto a high volume flow of flushing air.

It is then advantageous for the closing body, at a first disk element thereof and at a spaced-apart second disk element thereof, in each case, to engage over the first wall. In this way, upon unseating of the closing body from the counter device, both a first channel and a second channel separate from each other can be opened in a simple manner, with compact configuration of the filter cleaning device.

In particular, the second contact region is movable between the first wall and the second wall. In this manner, optimized supply of flushing air (incoupling of external air) to the at least one filter can be achieved.

In an embodiment, a first space is formed between the second wall and the first wall, in which space a second disk element of the closing body is movable, and a second space is formed between the first wall and a further wall, in which space a first disk element of the closing body is movable. This results in optimized supply of air to the at least one filter in a filter cleaning operation.

Alternatively, it is possible for the first contact region to be movable between the first wall and the second wall.

In particular, it is then provided for a first space to be formed between the second wall and a further wall, in which space a second disk element of the closing body is movable, and for a second space to be formed between the first wall and the second wall, in which space a first disk element of the closing body is movable.

In an embodiment, the filter cleaning device comprises a magnet device. Via the magnet device, the closing body can be driven in its movement from the closed position to the open position or the closing body can be held in the closed position of the at least one valve, depending on the particular configuration of the filter cleaning device.

In an embodiment, the magnet device comprises a switchable lifting solenoid, and an armature is connected to the closing body, wherein the closing body can be driven in its movement via coupling the armature to the lifting solenoid. The lifting solenoid cooperates with the armature. By application of current to the lifting solenoid, movement can be imparted to the armature and therefore to the closing body. Thus, the closing body can be given unseating movement in particular; the at least one valve can thereby be transferred from the closed position to the open position in particular.

In an alternative embodiment, the magnet device comprises a switchable holding magnet, wherein a counter element for the holding magnet is connected to the closing body. In particular, via the holding magnet, the closed position of the at least one valve can be held. When the holding magnet has a corresponding current applied thereto, the hold position ceases to be effective and the closing body can unseat from the counter device.

In an embodiment, a spring device is provided whose spring force seeks to move the at least one valve from the open position to the closed position. In particular, automatic return from the open position to the closed position can thereby be achieved.

In an embodiment, a manual actuation element is provided, which manual actuation element is connected to the closing body and serves to manually actuate a filter cleaning process. Filter cleaning can thereby be effected through manual operation.

In an embodiment, an elastic energy storage device is associated with the at least one valve and/or with an actuation element. In this connection, reference is made to EP 2 451 332 B1. This document is incorporated herein and made a part hereof by reference in its entirety and for all purposes. In particular, a quick opening action of the at least one valve can thereby be achieved.

It is advantageous for pressure-effective areas for the first contact region and the second contact region to differ from one another. That way, as a result of pressure differences between a normal pressure region and a negative pressure region, depending on the particular configuration of the closing body, the closing body can be automatically held in the closed position without an additional external force needing to be applied, or the closing body can be unseated from the counter device without an additional external force needing to be applied.

In an embodiment, the pressure-effective areas are configured to conform to one another such that, in operation of the suction apparatus, the at least one valve is in the closed position as a result of a pressure difference at the pressure-effective areas. The closing body is then urged against the counter device as a result of a pressure difference between a normal pressure region and a negative pressure region. To unseat the closing body from the counter device, an external force needs to be applied.

In particular, it is then provided for the pressure-effective areas to be configured to conform to one another such that a force need be exerted on the closing body for it to transition from the closed position to the open position. This can be realized by way of a lifting solenoid, for example.

In an alternative embodiment, the pressure-effective areas are configured to conform to one another such that, in operation of the suction apparatus, an external holding force is necessary to hold the at least one valve in the closed position. No external force is then needed to unseat the closing body from the counter device. The external holding force is provided, for example, by a holding magnet.

In particular, when the holding force ceases to exist, a pressure difference then brings the at least one valve from the closed position to the open position, wherein this transition then occurs automatically once the holding force ceases to exist.

It is particularly advantageous for a battery device to be provided for battery operation of the suction apparatus. In particular, the battery device is rechargeable. In particular, provision is made for both the suction unit and the filter cleaning device to be operated on battery power. The filter cleaning device in accordance with the invention can be operated in an effective manner with optimized filter cleaning even with the suction power reduced, as it may be the case in suction apparatuses that are operated using battery power.

In accordance with an exemplary embodiment of the invention, there is provided a method for cleaning a filter, in which method, by unseating a closing body of a valve from a counter device, the filter is acted upon by a filter cleaning air flow, wherein, in an open position of the valve, flushing air flows laterally past the closing body and flows through the closing body to the at least one filter, and/or wherein, in the open position of the valve, flushing air is incoupled at a plurality of regions spaced apart from one another in a height direction.

The method in accordance with the invention has the advantages that have already been described in connection with the suction apparatus in accordance with the invention.

In particular, the valve can be quickly opened and the filter can be provided with a high volume flow of flushing air within a relatively short time period, in order to effect filter cleaning.

The method in accordance with the invention can be carried out on the suction apparatus in accordance with the invention, or the suction apparatus in accordance with the invention can be operated, with respect to the filter cleaning, using the method in accordance with the invention.

In particular, it is advantageous, in a closed position of the valve, for the closing body to be in contact against the counter device at a first contact region and at a second contact region that are spaced apart in a height direction, and, in the open position of the valve, for flushing air to flow past both the first contact region and the second contact region to the filter. A quick opening action of the valve can thereby be achieved. A large volume flow of external air (flushing air) can be provided to the filter within a short time period for purposes of cleaning the filter and, correspondingly, the filter can then have a filter cleaning flow applied thereto.

Further advantageous embodiments of the method in accordance with the invention have already been discussed in the context of the suction apparatus in accordance with the invention.

The following description of preferred embodiments serves in conjunction with the drawings to explain the invention in greater detail.

### BRIEF DESCRIPTION OF THE DRAWINGS

FIG. 1 shows a schematic representation of an exemplary embodiment of a suction apparatus configured in the form of a stand-alone vacuum cleaner;

FIG. 2 illustrates a schematic sectional view of a first exemplary embodiment of a filter cleaning device in accordance with the invention, with a valve being shown in a closed position;

FIG. 3 illustrates the filter cleaning device in accordance with FIG. 2, with the valve being shown in an open position;

FIG. 4 shows schematically a time course of a volume of flushing air across a filter occurring in the filter cleaning device in accordance with FIG. 2, as compared to that produced by a filter cleaning device known from the prior art, indicated by the broken line illustration;

FIG. 5 illustrates a schematic sectional view of a second exemplary embodiment of a filter cleaning device in accordance with the invention, showing the valve as being closed;

FIG. 6 illustrates the filter cleaning device in accordance with FIG. 5, showing the valve as being open;

FIG. 7 illustrates a schematic sectional view of a third exemplary embodiment of a filter cleaning device in accordance with the invention, showing the valve as being closed;

FIG. 8 illustrates the filter cleaning device in accordance with FIG. 7, showing the valve as being open;

FIG. 9 illustrates a schematic sectional view of a fourth exemplary embodiment of a filter cleaning device in accordance with the invention, showing the valve as being closed;

FIG. 10 illustrates the filter cleaning device in accordance with FIG. 9, showing the valve as being open;

FIG. 11 illustrates a schematic sectional view of a fifth exemplary embodiment of a filter cleaning device in accordance with the invention, showing the valve as being open;

FIG. 12 illustrates a schematic sectional view of a sixth exemplary embodiment of a filter cleaning device in accordance with the invention, showing the valve as being closed; and

FIG. 13 illustrates the filter cleaning device in accordance with FIG. 12, showing the valve as being open.

### DETAILED DESCRIPTION OF THE INVENTION

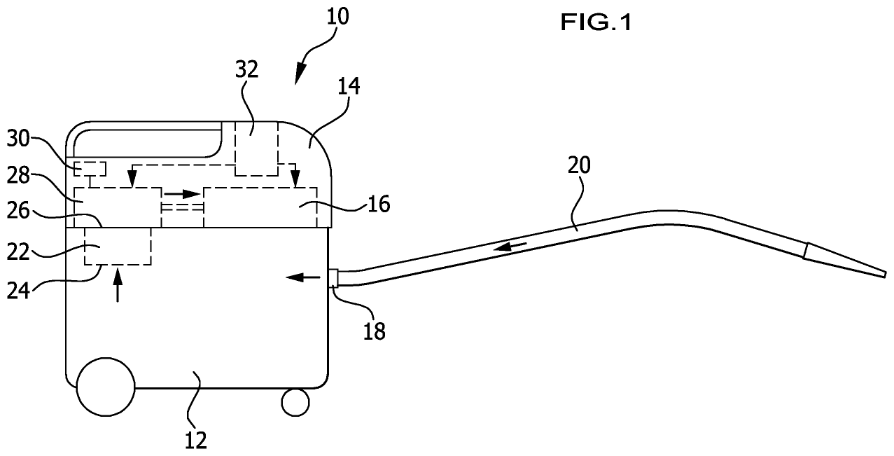

An exemplary embodiment of a suction apparatus in accordance with the invention is a vacuum cleaner 10 (FIG. 1) in the form of a stand-alone device.

The vacuum cleaner 10 comprises a suctioned material container 12. Formed in the suctioned material container 12 is a receiving space for suctioned material.

Arranged, and in particular removably arranged, at the suction container 12 is a suction head 14. Arranged at the suction head 14 is a suction unit 16. In an embodiment, the suction unit 16 comprises a suction fan and a motor, and in particular an electric motor, said motor rotatingly driving one or more impellers of the suction fan.

In operation of the vacuum cleaner 10, the suction unit 16 creates a suction flow. The suction flow is applied to the suctioned material container 12.

A port 18 for a suction hose or for a suction tube 20 is arranged at the suctioned material container 12.

It is also possible for the port 18 to be arranged at the suction head 14 and for the port 18 to be then operatively connected to the suctioned material container 12 for fluid communication therewith.

The suction hose 20 can have the suction flow applied thereto. Material to be suctioned can be sucked into the suctioned material container 12 via the suction hose 20.

The vacuum cleaner 10 comprises (at least) one filter 22. The filter 22 is arranged between the suctioned material container 12 and the suction unit 16. The filter 22 has a dirty side 24 which faces towards the suctioned material container 12, and has a clean side 26 which faces towards the suction unit 16. The filter 22 serves to retain dirt particles so that these are prevented from reaching the suction unit 16.

In an embodiment, the filter 22 is a planar pleated filter.

It is also possible for the filter to take the form of a cartridge filter, a candle filter, a bag filter, etc.

It is further possible for the vacuum cleaner 10 to comprise a plurality of filters and to comprise in particular filters which have different filtration efficiencies. In this context, reference is made, for example, to WO 2019/011429 A1. This document is incorporated herein and made a part hereof by reference in its entirety and for all purposes.

The vacuum cleaner 10 comprises a filter cleaning device 28. In operation of the vacuum cleaner 10, particles of dirt can accumulate on the filter 22 and cause it to become clogged. This results in reduced suction performance of the vacuum cleaner 10. The filter cleaning device 28 provides for cleaning the filter 22. In particular, the cleaning operation is performed from the clean side 26 of the filter 22. By use of the filter cleaning device 28, dirt particles can be dislodged from the filter 22 and transferred into the suctioned material container 12.

In particular, the filter cleaning device 28 is of such configuration that it will apply flushing air (external air) to the filter 22 and that this will cause dirt particles to become dislodged from the filter 22.

In an embodiment, provision is made for the filter cleaning device 28 to be demand-controlled. To this end, a control device 30 is provided. For example, one or more pressure sensors are used to determine when the filter is in need of cleaning and, upon detection of a corresponding condition, automatic filter cleaning is performed via the control device 30. In this respect, reference is made, for example, to WO 2015/139751 A1. This document is incorporated herein and made a part hereof by reference in its entirety and for all purposes.

It is also possible for the control device 30 to provide an indication that the filter is in need of cleaning; this then has to be performed manually by an operator.

In an embodiment, the vacuum cleaner 10 is powered by a battery device 32, and particular by a rechargeable battery device 32. Here, in particular, provision is made for the battery device 32 to provide the necessary electrical energy for the suction unit 16 and also to provide the necessary electrical energy for the filter cleaning device 28.

In an exemplary embodiment, the filter cleaning device 28 is arranged above the filter 22 at the suction head 14. It is, in principle, also possible for the filter cleaning device 28 to be arranged at the suctioned material container 12.

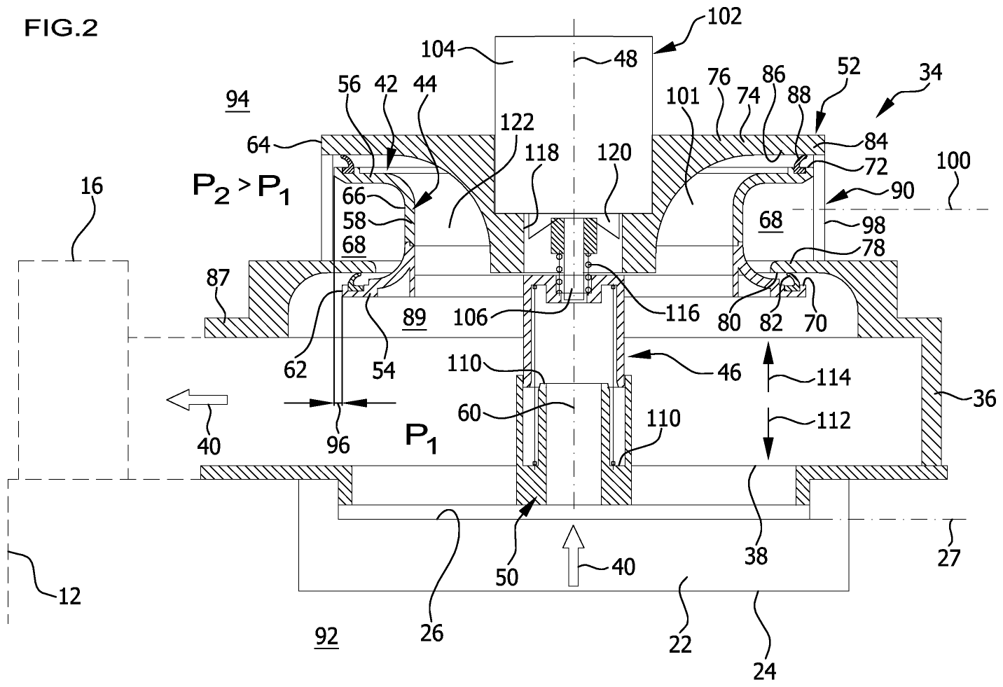

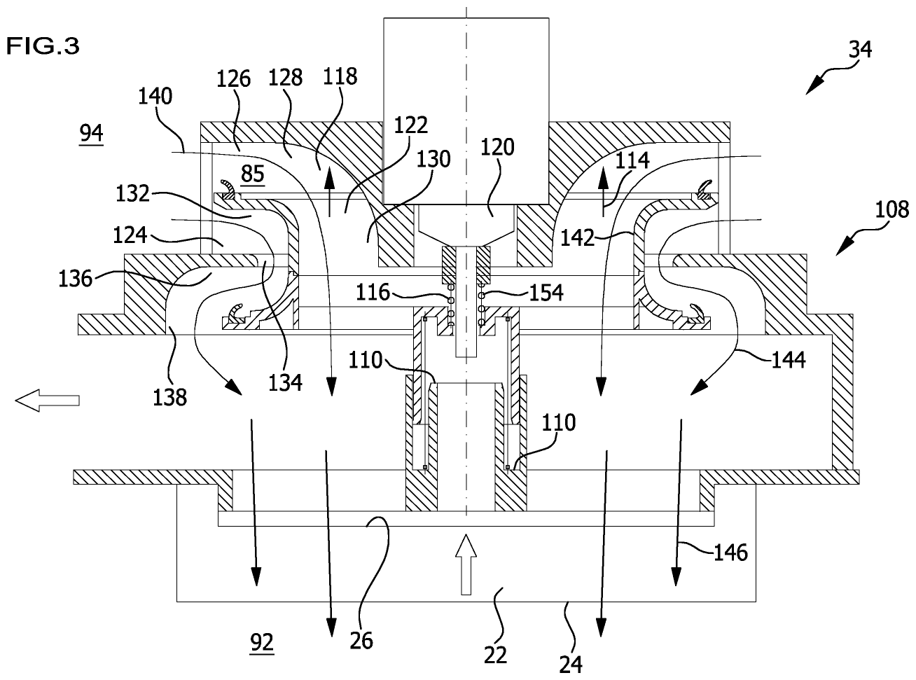

For example, in a first exemplary embodiment of a filter cleaning device, shown in FIGS. 2 and 3 and designated therein by 34, provision is made for the filter 22 to project into the suctioned material container 12.

The filter cleaning device 34 comprises a negative pressure chamber 36 which is operatively connected to the suction unit 16 for fluid communication therewith (FIG. 2).

The suction unit 16 creates a negative pressure in the area of the vacuum cleaner 10, which negative pressure is present in the negative pressure chamber 36 (indicated by the pressure p₁ in FIG. 2).

The filter 22 is arranged between the negative pressure chamber 36 and the suctioned material container 12. In operation of the vacuum cleaner 10, a negative pressure also exists in the suctioned material container 12, which negative pressure approximately corresponds to p₁ (and is generally greater in magnitude than p₁ because of the filter 22).

At the negative pressure chamber 36, the vacuum cleaner 10 has an opening 38 to the filter 22. Via the opening 38, the suction flow (indicated in FIG. 2 by the reference numeral 40) can be applied to the filter 22 and therefore to the suctioned material container 12. Also, the opening 38 allows a flushing air cleaning flow from the filter cleaning device 34 to be applied to the filter 22 (as will be explained later).

The filter cleaning device 34 comprises a valve 42 which comprises a closing body 44.

In an exemplary embodiment, the closing body 44 is arranged at a spindle 46 in a manner fixed against movement relative to the spindle 46. The spindle 46 is movable in a height direction 48. The closing body 44 is thereby also linearly displaceable in the height direction 48.

The filter 22 has at the clean side 26 thereof an envelope 27 (FIG. 2) which is in particular an envelope plane. The height direction 48 is transverse and in particular perpendicular to said envelope 27.

The spindle 46 is guided for linear displacement on a first guide device 50. The first guide device 50 is fixed against movement relative to the negative pressure chamber 36.

Further, provision is made for the closing body to be guided for displacement, and to be for example guided for slidable displacement, on a second guide device 52. The second guide device is also fixed against displacement relative to the negative pressure chamber 36.

In an exemplary embodiment, the first guide device 50 is centrally arranged. The second guide device 52 is peripherally arranged.

The closing body comprises a first disk element 54. The closing body further comprises a second disk element 56 which is in spaced-apart relationship to the first disk element 54 in the height direction 48. Positioned between the first disk element 54 and the second disk element 56 is a connection region 58.

In particular, the closing body 44 is rotationally symmetric in relation to an axis of symmetry 60 which is parallel to the height direction 48. In particular, the axis of symmetry 60 is a central axis, wherein the first guide device 50 is located along said central axis.

In an embodiment, the first disk element 54 and the second disk element 56 each have a circular circumference.

In an exemplary embodiment, the closing body 44 is of two-part configuration. It is formed of two parts which are connected to one another. The first disk element 54 and part of the connection region 58 are formed on the one part and the second disk element 56 and part of the connection region 58 are formed on the second part.

The first disk element 54 has an end face 62. The second disk element 56 has an end face 64. As mentioned above, the first disk element 54 and the second disk element 56 are of circular shape at their end faces 62 and 64 respectively.

The first disk element 54 faces towards the filter 22. The second disk element 56 faces away from the filter 22. The first disk element 54 is thereby located between the filter 22 and the second disk element 56.

The connection region 58 has an outer contour 66 which is set back from the end faces 62, 64. A space 68 is thereby laterally formed at the closing body 44, between the first disk element 54, the connection region 58 and the second disk element 56.

In particular, said space 68 has an annular shape or annularly surrounds the connection region 58.

The space 68 has the second disk element 56 projecting thereacross towards the top and has the first disk element 54 projecting thereacross towards the bottom (towards the filter 22).

A first contact region 70 is arranged or formed at the first disk element 54. A second contact region 72 is arranged or formed at the second disk element 56.

The first contact region 70 is arranged at the first disk element 54 on a side thereof facing away from the filter 22. The second contact region 72 is arranged at the second disk element 56 on a side thereof away from the filter 22.

The filter cleaning device 34 comprises a counter device 74 for the closing body 44. The counter device 74 is arranged at the negative pressure chamber 36.

The counter device 74 is formed by a housing 76.

The counter device 74 forms a valve seat or closing body seat.

The closing body 44 is movably arranged in the housing 76.

The counter device 74 comprises a first wall 78. The first wall 78 projects into the space 68 around the connection region 58 of the closing body 44. The first wall 78 is stationarily arranged. The first disk element 54 and the second disk element 56 are movable relative to the first wall 78.

Formed at the first wall 78 is a first counter contact region 80 for the first contact region 70 at the closing body 44.

A first sealing device 82 is associated with the first contact region 70 and the first counter contact region 80. In particular, the first sealing device 82 is in the form of a ring which in particular is symmetrical relative to the axis of symmetry 60.

In an exemplary embodiment, the first sealing device 82 is arranged at the closing body 44. As an alternative, it is possible for the corresponding sealing device to be positioned at the counter device 74 and, here, at the first wall 78. It is further possible for a sealing device to be arranged at both the counter device 74 and the first disk element 54 of the closing body 44.

The first sealing device 82 serves to provide a fluid seal when the closing body 44 is in contact against the first counter contact region 80 via the first contact region 70.

The counter device 74 further comprises a second wall 84. The second wall 84 is in spaced-apart relation to the first wall 78 and is further away from the filter 22 than the first wall 78, relative to the height direction 48; the first wall 78 is located between the second wall 84 and the filter 22 relative to the height direction 48.

Arranged or formed at the second wall 84 is a second counter contact region 86 for the second contact region 72 at the second disk element 56 of the closing body 44.

A second sealing device 88 is associated with the second contact region 72 and the second counter contact region 86. In particular, the second sealing device 88 is in the form of a sealing ring.

The second sealing device 88 is located at the second disk element 56 (cf. FIG. 2) or at the counter device 74. It is further possible for the second sealing device 88 to comprise parts that are located at both the counter device 74 and the closing body 44.

The counter device 74 and the closing body 44 are configured to conform to one another such that when the closing body 44, at the first contact region 70, contacts the counter device 74 (at the first counter contact region 80) and fluid tightness is thereby achieved there, the second contact region 72 also contacts the second counter contact region 86 and fluid tightness is also achieved there (FIG. 2).

When the first contact region 70 and the second contact region 72 of the closing body 44 are in contact against the counter device 74, the valve 42 is in a closed position 90 (FIG. 2).

When in operation, the vacuum cleaner 10 presents a negative pressure region 92. The negative pressure region 92 is the region that has a suction flow applied thereto. The filter 22 is located at the negative pressure region 92. An interior space of the negative pressure chamber 36 is located at the negative pressure region 92.

When the suction unit 16 creates a suction flow, the negative pressure region 92 is under negative pressure relative to an outside space, and in particular relative to atmospheric pressure. Here, the negative pressure can be different at different locations of the negative pressure region 92.

The vacuum cleaner 10 further has a normal pressure region 94. The normal pressure region 94 surrounds the negative pressure chamber 36 and surrounds the filter cleaning device 34. The valve 42, when in the closed position 90, serves to fluid-tightly isolate the normal pressure region 94 from the negative pressure region 92. When in “normal” suction operation, fluid-tight isolation of the normal pressure region 94 from the negative pressure region 92 prevents leakage flows from occurring.

In order to provide flushing air for a filter cleaning operation on the filter 22 by the filter cleaning device 34, provision is made for operative connection between the normal pressure region 94 and the negative pressure region 92 for fluid communication therebetween.

A pressure p₂ is present in the normal pressure region 94, which pressure p₂ is of greater magnitude than the pressure p₁ prevailing in the negative pressure region. In an embodiment, the pressure p₂ is approximately constant and is at the external atmospheric pressure.

It is also possible for the pressure p₂ in the normal pressure region 94 to be of greater magnitude than atmospheric pressure. By way of example, in an embodiment, provision is made for a compressor to apply pressure to the normal pressure region 94, creating therein a pressure p₂ that is above the atmospheric pressure. Such an embodiment is used, for example, in a sweeping machine.

The closing body 44 presents effective areas for pressure application at the first disk element 54 and the second disk element 56 thereof.

In an exemplary embodiment (cf. FIGS. 2 and 3), the closing body 44, at the first disk element 54 and the second disk element 56, is formed with respect to the pressure-effective areas such that the closing body 44 is held in the closed position 90 as a result of the pressure difference created between the normal pressure region 94 and the negative pressure region 92 in the closed position 90. To this end, the second disk element 56 has a larger diameter than the first disk element 54. The end face 64 of the second disk element 56 is spaced further from the axis of symmetry 60 than is the end face 62 of the first disk element 54; the end face 62 is set back relative to the end face 64 by a distance D (cf. reference numeral 96 in FIG. 2).

For example, the effective diameter for sealing of the second disk element 56 is made greater than the effective diameter of the first disk element 54 by a factor greater than unity to about 1.3.

This difference in the configuration of the first disk element 54 and the second disk element 56 causes the force due to the pressure difference between the normal pressure region 94 and the negative pressure region 92 to urge the closing body 44 against the counter device 74. The housing 76 of the counter device 74 comprises an opening or comprises a plurality of openings 98 via which air (from the normal pressure region 94) can be admitted into the housing 76.

In particular, an opening 98 has a normal for a mouth thereof which is transverse and in particular perpendicular to the height direction 48. In FIG. 2, said normal for the mouth is indicated by the reference numeral 100.

Starting from the one or more openings 98, the housing 76 comprises a space 101 in which the closing body 44 is movable. The space 101 is connected to a corresponding space of the negative pressure chamber 36 and is thereby also connected to the filter 22.

The filter cleaning device 34 comprises a magnet device 102. The magnet device 102 comprises an (electro)magnet 104 which is controlled by the control device 30.

The magnet 104 is positioned centrally and, in particular, coaxially relative to the axis of symmetry 60 and is fixed with respect to displacement relative to the negative pressure chamber 36.

An armature 106 is located at the spindle 46. The armature 106 is also positioned on the central axis 60.

The armature 106 cooperates with the magnet 104.

In the closed position 90 of the valve 42, the force caused by the pressure difference provides for the closing body 44 to be in contact against the counter device 74.

The magnet 104 is configured in the form of a lifting solenoid. The armature 106 takes the form of a movable iron core for example.

By application of current to the magnet 104, the latter is caused to exert a force on the armature 106 and therefore on the closing body 44. The closing body 44 can unseat from the counter device 74 (FIG. 3). The valve 42 is opened; the valve 42 is in an open position 108.

Here, it is in principle possible for the valve 42 to assume, relative to the height direction 48, different positions when it is in the open position 108.

A maximum stroke of the closing body 44, starting from the closed position 90, is predetermined by virtue of a stop 110 located at the first guide device 50 (or, alternatively or additionally, by virtue of a stop located at the second guide device 52).

Starting from the closed position 90, as the valve 42 is being opened, the closing body 44 moves in a direction 112 (cf. FIG. 2), towards the at least one filter 22.

In order to attain the closed position 90 from the open position 108, the closing body 44 moves in a direction 114 (cf. FIG. 3) which is the opposite direction to the direction 112 and which is directed away from the filter 22.

By virtue of a corresponding control of (application of current to) the (electro)magnet 104, the closing body 44 can be controllably unseated from its counter device 74 in order to controllably create a flushing air cleaning flow.

In particular, the closing body 44 is supported via a spring device 116. The spring device 116 is arranged such that it seeks to exert a force which acts as a restoring force and which acts in the direction 114. In particular, the spring device 116 is compressed when the closing body 44 is brought from the closed position 90 to the open position 108. This requires an external force which is applied to the armature 106 via the magnet 104. When such force, which overcomes the corresponding force of the spring device 116, is no longer present, then the spring device 116 (in addition to the existing pressure difference) restores the closing body 44 to the closed position 90 by moving same in the direction 114. Thus, the force of the spring device 116 acts in the direction 114.

In an embodiment, the counter device 74 comprises a central opening 118 about the axis of symmetry 60. The magnet 104 is positioned above said opening 118. The armature 106 is positioned, at least in part, in the opening 118.

A sealing collar 120 is positioned between the armature 106 or the spindle 46 and the magnet 104, which permits the movability of the armature 106 (in order to allow transition between the closed position 90 and the open position 108 and, vice versa, between the open position 108 and the closed position 90), while maintaining a fluid-tight seal of the space 101 to the magnet 104.

The filter cleaning device 28 comprises (at least) a first channel 122 and a second channel 124 separate from the first channel 122, for conducting flushing air.

The first channel 122 comprises a first region 126 (cf. FIG. 3) which is oriented in a direction transverse to the height direction 48. Flushing air flowing in the first region 126 has a principal direction of flow which is oriented at least approximately transverse to the height direction 48. The first region 126 extends from the opening 98 in the housing 76. The first region 126 is of annular shape.

The first region 126 is formed between a top side of the closing body 44 and, here, between the second disk element 56 and the second wall 84.

Adjoining the first region 126 is a region 128 of directional change. The region 128 of directional change serves the purpose of changing the direction of flow. Adjoining the region 128 of directional change is a second region 130 of the first channel 122. The second region 130 of the first channel 122 passes through the closing body 44 and, here, passes through the first disk element 54, the connection region 58 and the second disk element 56, and it opens to the negative pressure chamber 36.

A principal direction of flow in the second region 130 of the first channel 122 is at least approximately parallel to the height direction 48.

The second region 130 is at least partially bounded by the second wall 84, in particular wherein the second wall 84 is formed with an arcuate-shaped configuration and comprises a region which is at least approximately parallel to the height direction 48.

In the closed position 90 of the valve 42, the first channel 122 at its input side is closed to the normal pressure region 94. The first region 126 is closed relative to the normal pressure region 94 (cf. FIG. 2). Here, the first region 126 is fluid-tightly closed off so that, with the valve in the closed position 90, by virtue of contact of the second contact region 72 against the second counter contact region 86, no air will be allowed to enter the input side of the first channel 122 from a normal pressure region 94.

The first channel 122 at its second region 130 is in permanent operative connection and fluid communication with the negative pressure chamber 36; i.e., it is at its output side in permanent connection to the negative pressure chamber 36.

The second channel 124 comprises a first region 132 (cf. FIGS. 2 and 3) which is oriented in a direction transverse to the height direction 48. When flushing air flows in the first region 132 of the second channel 124, a principal direction of flow in the first region is transverse to the height direction 48.

The first region 132 forms an entrance to the second channel 124. Via the first region 132, the second channel 124 at its input side is in permanent connection to the normal pressure region 94 (cf. FIGS. 2 and 3).

The first region 132 of the second channel 124 is formed between the first wall 78 and the second disk element 56.

Adjoining the first region 132 is a region 134 of directional change. The region 134 of directional change comprises a second region in which a principal direction of flow is at least approximately parallel to the height direction 48.

Adjoining the region 134 of directional change is a further first region 136 which is also oriented in a direction transverse to the height direction 48. Adjoining the further first region 136 is a further second region 138 which is oriented at least approximately parallel to the height direction 48. In the further second region 138, a principal direction of flow is at least approximately parallel to the height direction 48. The further second region 138 of the second channel 124 opens to the negative pressure chamber 36.

The second channel 124, at its input side, opens to the normal pressure region 94 and, at its output side, opens to the negative pressure chamber 36 and, thereby, to the negative pressure region 92.

The second channel 124 is, via the first region 132 thereof, in permanent connection to the normal pressure region 94, i.e. the second channel 124 is connected to the normal pressure region 94 in both the closed position 90 of the valve 42 and the open position 108 of the valve 42 (cf. FIGS. 2 and 3).

The second channel 124 is, via its further second region 138, at the output side thereof, in operative connection and fluid communication with the negative pressure region 92 (and therefore with the negative pressure chamber 36) only when the valve 42 is in its open position 108. In the closed position 90, the second channel 124 is fluid-tightly closed relative to the negative pressure region 92 by virtue of contact of the first contact region 70 against the first counter contact region 80.

The first channel 122 and the second channel 124 are of annular configuration. In particular, the first channel 122 and the second channel 124 are of annular shape in any cross-section, relative to the height direction 48.

In the open position 108 of the valve 42, the first channel 122 allows flushing air in a first partial flow 140 (cf. FIG. 3) to be supplied through the closing body 44 and, here, through an opening 142 in the closing body, to the filter 22.

The second channel 124 allows a second partial flow 144 of flushing air to be passed laterally past the closing body 44, and thereby externally past the connection region 58 along the outer contour 66, and to be supplied to the filter 22.

A first space 85 is formed between the second wall 84 and the first wall 78. The second disk element 56 of the closing body 44 is movable in the first space 85. A further wall 87 exists which is located between the first wall 78 and the filter 22. The further wall 87 can also be part of the negative pressure chamber 36. A second space 89 is formed between the first wall 78 and the further wall 87. The first disk element 54 is movable in the second space 89.

The filter cleaning device 34 works as follows:

In suction operation of the vacuum cleaner 10, the suction unit 16 creates a suction flow. A negative pressure is present in the negative pressure region 92, relative to the normal pressure region 94. In normal operation, the valve 42 is closed; it is in the closed position 90 thereof. The contact regions 70, 72 are in contact against the counter device 74. The negative pressure chamber 36 is thereby fluid-tightly closed relative to the normal pressure region 94.

When a filter cleaning operation is initiated, the closing body 44 is moved.

To this end, the magnet 104 has a corresponding current applied to it (under the control of the control device 30). This induces movement of the armature 106, and the resultant effect for the closing body 44 is to move away from the counter device 74.

Thereby, the first channel 122 is opened on the input side thereof and the second channel 124 is opened on the output side thereof.

As a result of the pressure difference between the normal pressure region 94 and the negative pressure region 92, flow of the first partial flow 140 and the second partial flow 144 is induced. The two partial flows 140, 144 are annular.

The first partial flow 140 flows through the closing body 44. The second partial flow 144 flows around the closing body 44.

A corresponding flushing flow flows into the negative pressure chamber 36 and (passing therethrough) flows from the negative pressure chamber 36 to the filter 22.

A cleaning flow is created which acts on the filter 22 (FIG. 3; the cleaning flow is indicated by the reference numeral 146). The filter 22 is flushed with the corresponding flushing flow. Adhered dirt particles can be dislodged and fall into the suctioned material container 12.

Here, the filter cleaning operation is realized such that the suction flow of the suction unit 16 continues to be present at the negative pressure chamber 36.

In the solution in accordance with the invention, when in the closed position 90, the sealing action relative to the normal pressure region 94 is achieved by the closing body 44 at (at least) two levels, via the first contact region 70 and the second contact region 72. The first contact region 70 and the second contact region 72 are simultaneously effective when in the closed position 90. The first contact region 70 and the second contact region 72 are offset from one another in the height direction 48.

When the closing body 44 is unseated from the closed position 90, mouth openings are released at the first channel 122 and the second channel 124, which openings permit flushing air (external air) to flow therethrough. Here, a radial opening area increases with valve stroke.

Flushing air then flows at the first contact region 70 and the second contact region 72 and to the filter 22. Correspondingly, flushing air also flows past the first counter contact region 80 and the second counter contact region 86 to the filter 22.

In the filter cleaning device 34, the closing body 44 presents different effective sealing diameters at the first disk element 54 and at the second disk element 56, with attendant different pressure effects. In the present embodiment, this is dimensioned such that the closing body 44 is held in the closed position 90 as a result of the pressure difference between the negative pressure region 92 and the normal pressure region 94, without assistance from external force.

The fluid-tight sealing actions occurring at the first contact region 70 and at the second contact region 72 cease to be effective at approximately the same time the closing body 44 is unseated from the closed position 90.

A large cross-sectional air flow area for flushing air flow to the filter 22 can be achieved upon opening of the valve 42. Upon opening the latter, a relatively large cross-sectional air flow area can be achieved quickly.

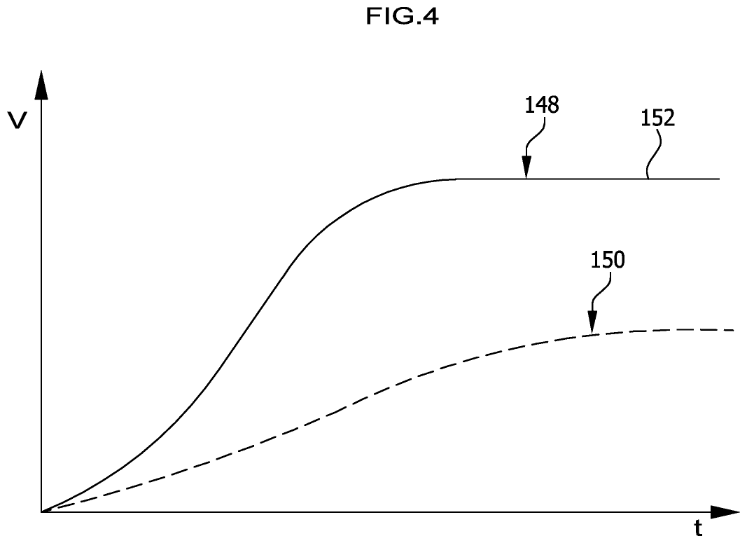

FIG. 4 diagrammatically represents, by a solid line, a time course of a volume of filter cleaning air across the filter 22 as provided by the solution in accordance with the invention. It will be observed that there is a sharp rise within a relatively short time period and then a relatively high level is reached. Here, measurements were taken in relation to a suctioned material container 12 having a capacity of 201.

The broken line illustration, by comparison, shows the corresponding course for a conventional filter cleaning device as it is described in DE 10 2010 029 518 A1.

As will be apparent from comparing the trajectories of courses 148 and 150, the solution in accordance with the invention will provide the sharper rise and the higher plateau 152.

The steeper course 148 is to be attributed to the fact that the opening of the valve 42 occurs more quickly. A higher level 152 stands for a higher amount of flushing air (external air as cleaning air).

In the solution according to the invention, by virtue of the contact regions 70, 72 offset in height with respect to one another, upon opening of the valve 42, an annular gap opening is achieved at different levels and with large diameter. As has already been mentioned, the cross-section of the opening increases with valve stroke. For example, an impulse of magnitude 90 ms applied to the magnet 104 (lifting solenoid) opens the valve 42.

It is, in principle, possible for an additional energy storage spring 154 (cf. FIG. 3) to be provided, which energy storage spring 154 is arranged, for example, at the first guide device 50 and which serves to increase the opening velocity. A force effect of the energy storage spring 154 seeks to unseat the closing body 44 from the counter device 74. The energy storage spring 154 must be correspondingly dimensioned taking into account the spring device 116 and the pressure force which retains the closing body 44 seated in the closed position 90, in contact against the counter device 74.

The filter cleaning device 34 in accordance with the invention has been shown to emit relatively low noise levels in respect of popping noise. Thus, reduced pop noise levels by about 3.6 dB(A) or more are achieved, when compared to a filter cleaning device as it is described in DE 10 2010 029 518 A1.

The filter cleaning device 34 allows for effective filter cleaning even if the suction fan is configured for lower power, as for example in the case of a vacuum cleaner 10 that operates from a battery device 32.

In an embodiment, provision is made for the magnet 104 to be periodically energized. By way of example, a series of three opening impulses of about 90 ms or 100 ms duration are applied in close succession every 15 s.

In an embodiment, provision is made for the first contact region 70 at the first disk element 54 to have a diameter of about 115 mm. The second contact region 72 at the second disk element 56 has a diameter of about 120 mm.

A stroke of the valve 42, and therefore a stroke of the closing body 44 in the height direction 48, starting from the closed position 90, is at least 5 mm in particular. Preferably, the stroke is no more than 50 mm.

In a concrete exemplary embodiment, the valve stroke is in the range between 10 mm and 20 mm.

Provision is made for the distance between the first contact region 70 and the second contact region 72 in the height direction 48 to be at least 6 mm, and preferably at least 10 mm. In a concrete embodiment, said axial distance is 30 mm.

Preferably, a diameter at the second contact region 72 is at least 50 mm. The sealing diameter at the first contact region 70 is no more than 200 mm.

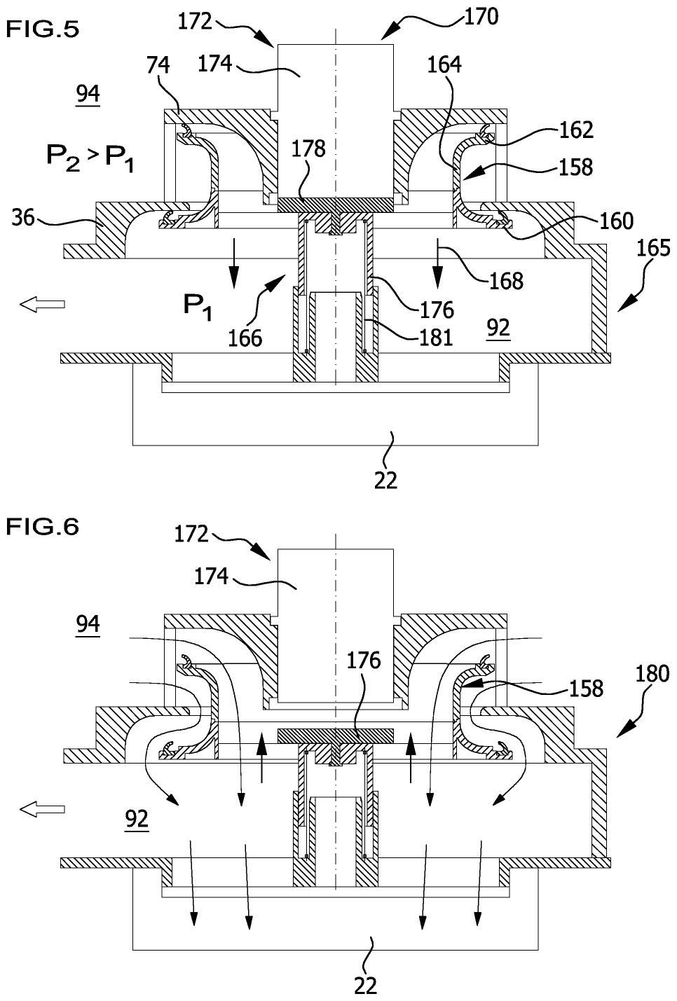

A further exemplary embodiment of a filter cleaning device, shown in FIG. 5 (with the valve closed) and in FIG. 6 (with the valve open) and designated therein by 156, comprises a closing body 158 having a first disk element 160, a second disk element 162 and a connection region 164 between the first disk element 160 and the second disk element 162. As with the closing body 44, a first contact region is arranged at first disk element 160 and a second contact region is arranged at the second disk element 162.

The closing body 158 differs from the closing body 44 in that an effective pressure area at the first disk element 160 is greater than that at the second disk element 162; with respect to the first contact region, the first disk element 160 is of greater diameter than the second disk element 162.

For example, the effective diameter of the second disk element 162 is smaller than the effective diameter of the first disk element 160 by a factor of up to 0.7.

The counter device is generally of identical configuration to the counter device 74. It is therefore annotated with the same reference numeral.

Thus, in a closed position 165 (FIG. 5) of a corresponding valve 166 having the closing body 158, when the contact regions of the closing body 158 are in contact against the counter device 74, a force acts on the closing body 158, which force seeks to move same in the direction of the filter 22. The corresponding direction of action is indicated in FIG. 5 by the arrows designated 168.

To hold the valve 166 in the closed position 165 requires a holding device 170. The holding device 170 is configured in the form of a magnet device 172. The magnet device 172 comprises a holding magnet 174, which is in particular an electromagnet. The holding magnet 174 is fixedly connected to a negative pressure chamber 36. The closing body 158 is movable relative to the holding magnet 174.

In particular, the holding magnet 174 is controlled by the control device 30.

The valve 166 comprises a spindle 176 at which a magnetic holding plate 178 is located. In the closed position 165 of the valve 166, the holding magnet 174 has a current applied thereto such that it exerts a magnetic force on the holding plate 178, and therefore on the spindle 176 along with the closing body 158. The closed position 165 of the valve 166 is thereby fixed.

To open the valve 166 and provide the transition to an open position 180 (FIG. 6), the current to the holding magnet 174 is changed such that the magnetic force of the holding magnet 174 is no longer sufficient to hold the closing body 158 in the closed position 165 through the holding plate 178. Under the effect of the pressure difference between the negative pressure region 92 and the normal pressure region 94, the valve 166 opens and the contact regions of the closing body 158 are unseated from the counter device 74. Flushing air can then reach the filter 22 as has been described above by reference to the filter cleaning device 34.

In this respect, the filter cleaning device 156 works in the same way as discussed for the filter cleaning device 34.

The filter cleaning device 156 can be considered as a type of kinematic inversion of the filter cleaning device 34. In the case of the filter cleaning device 34, the pressure difference between the negative pressure region 92 and the normal pressure region 94 effects holding the closing body 44 in the closed position 90.

In the case of the filter cleaning device 156, by reason of the corresponding configuration of the closing body 158, to hold the closing body 158 at the counter device 74 in the closed position 165, it is necessary to have a holding force.

In the case of the filter cleaning device 34, in order to attain the open position 108 of the valve 42, the magnet device 102 having the lifting solenoid 104 exerts a corresponding force on the closing body 44 to move same in the direction of the filter 22 and thereby to achieve the open position 108.

In the filter cleaning device 156, by removing (or reducing) the holding force exerted by the holding magnet 174, the closing body 158 is moved to the open position 108 in the direction towards the filter 22 as a result of the pressure difference.

It is, in principle, also possible for the holding magnet 174, in cooperation with the magnetic holding plate 178, to be configured such that when it has no current applied to it, it holds the closed position 165 and, when current is applied, the holding force is reduced in order to move the valve 166 out of the closed position 165.

In the filter cleaning device 156, when in the closed position 165, contact of the closing body 158 against the counter device 74 is also achieved at at least two levels.

When the valve 166 is being opened, the resulting flow pattern is generally similar or identical to that produced in the filter cleaning device 34, with the concomitant benefits described in relation thereto.

In particular, the filter cleaning device 156 comprises a spring device 181 which acts as a restoring spring device and seeks to move the valve 166 from the open position 180 to the closed position 165.

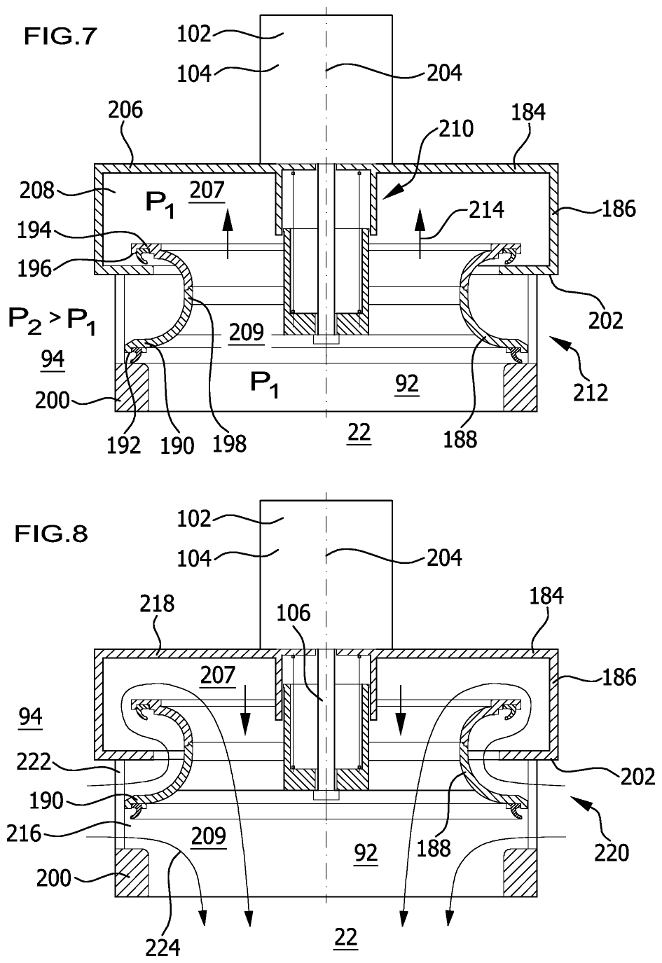

A further exemplary embodiment of a filter cleaning device 182 in accordance with the invention, illustrated schematically in FIG. 7 (in the closed position of a valve) and in FIG. 8 (in an open position of the valve), comprises a counter device 184 having a housing 186.

A closing body 188 is guided for displacement in the housing 186. The closing body 188 comprises a first disk element 190 having a first contact region 192. It further comprises a second disk element 194 having a second contact region 196. A connection region 198 is positioned between the first disk element 190 and the second disk element 194. The counter device 184 comprises a first wall 200. This has a first counter contact region for the first contact region 192.

The counter device further comprises a second wall 202 which has a counter contact region for the second contact region 196.

The first wall 200 and the second wall 202 are in spaced-apart relation to one another in a height direction 204. The first contact region 192 and the second contact region 196 at the closing body 188 are also in spaced-apart relation to one another in the height direction 204, as with the filter cleaning device 34 or 156.

The housing 186 comprises a third wall 206. A space 208 is formed between the third wall 206 and the second wall 202.

Formed between the second wall 202 and the third wall 206 as a further wall is a first space 207. The second disk element 194 is movable in the first space 207.

Formed between the first wall 200 and the second wall 202 is a second space 209. The first disk element 190 is movable in the second space 209.

A valve 210 having the closing body 188 is movable relative to the counter device 184. Starting from a closed position 212 of the valve 210 (FIG. 7), in which the closing body 188 has its contact regions 192, 196 in contact against the counter device 184, the closing body 188 is movable away from the Filter 22 in a direction 214.

The filter cleaning device 182 comprises a first channel 216 and a second channel 218.

In the closed position 212 of the valve 210 (FIG. 7), the first channel 216 and the second channel 218 are fluid-tightly closed relative to a normal pressure region 94.

At a valve stroke (FIG. 8) in which the valve 210 is in an open position 220, the first channel 216 and the second channel 218 are, at the input sides thereof, open to the normal pressure region 94.

This then allows flushing air to flow in and pass to the filter 22 (the filter is not depicted in FIGS. 7, 8; its location is indicated by the reference numeral 22).

Here, the first channel 216 has a first region 222 at which an inlet is located. The inlet allows inflow of air when in the open position 220. Here, a partial flow of air flows past an outer contour of the closing body 188 and flows in the housing 186 between a top side of the closing body 188 and the third wall 206. The partial flow undergoes a directional change and then flows through the closing body 188 to the filter 22.

A further partial flow 224 flows in via a first region of the second channel 218 and undergoes directional change towards the filter 22.

In an embodiment, the first disk element 190 has a larger diameter relative to the first contact region 192 than has the second disk element 194 relative to a second contact region 196.

This means that, as a result of the pressure difference between the normal pressure region 94 and a negative pressure region 92, the closing body 188 is urged against the counter device 184 and the closed position 212 is secured.

To bring the valve 210 out of the closed position 212, it is necessary to have an external force.

To this end, a magnet device corresponding to the magnet device 102 is provided (the same reference numbers are used to refer to the same elements). The magnet device comprises a lifting solenoid 104 which acts on a corresponding armature 106.

The first contact region 192 and the second contact region 196 at the closing body 188 face towards the filter 22, i.e. face in a direction opposite to the direction 214.

In the filter cleaning device 182, a transition from the closed position 212 to the open position 220 is realized by a movement of the closing body 188 in a direction away from the filter 22 and, thereby, in a sense, in an upward direction.

In the case of the filter cleaning devices 34 and 156, opening of the corresponding valve 42 and 166 respectively is realized as a result of movement of the closing body 44 and 158 respectively in a direction towards the filter 22.

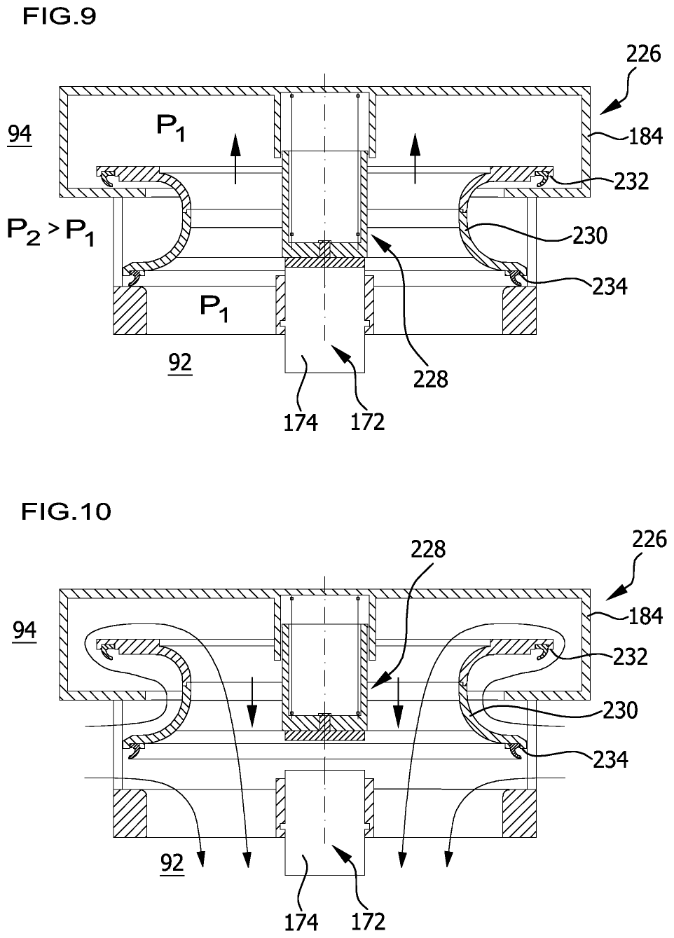

A further exemplary embodiment of a filter cleaning device, illustrated in FIGS. 9 and 10 and designated therein by 226, wherein FIG. 9 shows a closed position of a valve 228 and FIG. 10 shows an open position of the valve 228, comprises a closing body 230. A counter device is provided, which counter device has generally the same configuration as the counter device 184. The same reference numerals are used for elements that are the same as those described for the filter cleaning device 182.

The closing body 230 is configured such that it has a larger effective pressure diameter relative to a second contact region 232 than it has for a first contact region 234.

The pressure difference between a normal pressure region 94 and a negative pressure region 92 causes movement of the closing body away from its contact against the counter device 184.

Therefore, to hold the closed position in accordance with FIG. 9, it is necessary to have a holding force. To this end, for example, a magnet device is used, said magnet device corresponding to the magnet device 172 having a holding magnet 174. The same reference numerals are used for elements that are the same as those described for the filter cleaning device 156.

In this respect, the filter cleaning device 226 works in the same way as has been discussed for the filter cleaning device 156. Just as the filter cleaning device 156 represents a type of kinematic inversion of the filter cleaning device 34, so does the filter cleaning device 226 represent a type of kinematic inversion of the filter cleaning device 182.

In the filter cleaning devices 182 and 226, a transition from the closed position 212 to the open position 220 is realized by movement of the corresponding closing body 188 and 230 respectively in a direction away from the filter 22 and, thereby, in a sense, in an upward direction.

Again, as has been described for the case of the filter cleaning devices 34 and 156, a filter cleaning flow can be created that achieves a sharp increase and a high level (cf. FIG. 4) and thereby achieves effective filter cleaning.

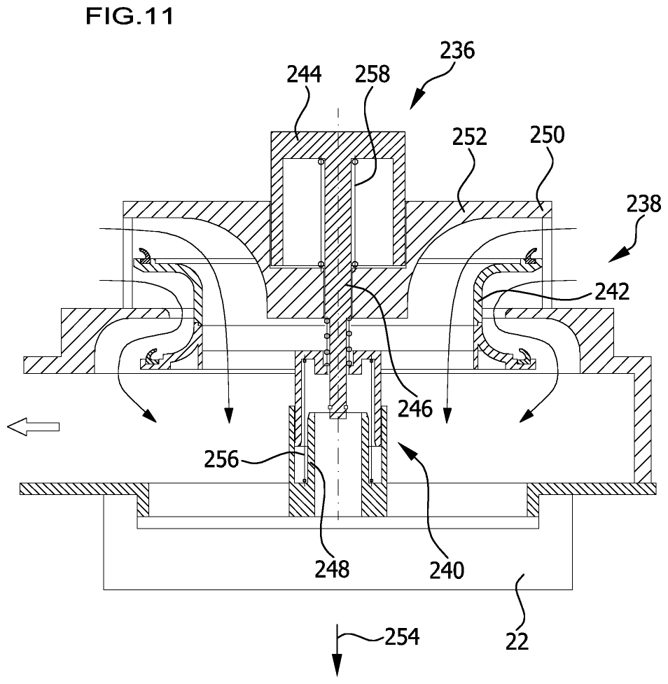

A further exemplary embodiment of a filter cleaning device in accordance with the invention, illustrated schematically in FIG. 11 and designated therein at 236, wherein a valve 240 having a closing body 242 is shown as being in an open position, has the same configuration as the filter cleaning device 34 with respect to the configuration of the closing body and flow routing.

The filter cleaning device 236 is provided for manual actuation. The filter cleaning device 226 comprises a manual actuation element 244. The manual actuation element 244 is connected to a spindle 246. The manual actuation element 244 is connected to the closing body 242.

The manual actuation element 244 can be accessed directly by an operator, or a corresponding transfer mechanism is provided to transfer hand operation by an operator to the manual actuation element 244.

The closing body 242 is guided via a first guide device 248 which is located centrally, and a second guide device which is located peripherally, for displacement on a counter device 252 for the closing body 242.

The closing body 242 is unseated by pressure on the manual actuation element 244 in a direction 254 towards the filter 22, in the same manner as described above for the case of the filter cleaning device 34 using the closing body 44. (In the filter cleaning device 34, the unseating is effected by virtue of the lifting solenoid 104.)

A spring device 256 ensures that the closing body 242 will be restored to its closed position, starting from which the manual actuation element 244 is actuated.

The closing body is configured in the same manner as described for the closing body 44 employed in the filter cleaning device 34. A closed position of the valve 240 is thereby ensured by the pressure difference created between a normal pressure region and a negative pressure region. To bring the closing body 242 out of contact with the counter device 252, i.e., to unseat the valve 240 from a closed position, requires an external force.

Here, it is in principle possible for the manual actuation element 244 to be configured as an actuating button and for a spring device 258 to be provided which is configured as an energy storage device in particular. The above-mentioned spring device 256 provides restoration of the manual actuation element 244.

With respect to flow routing, the filter cleaning device 236 works in the same manner as does the filter cleaning device 34.

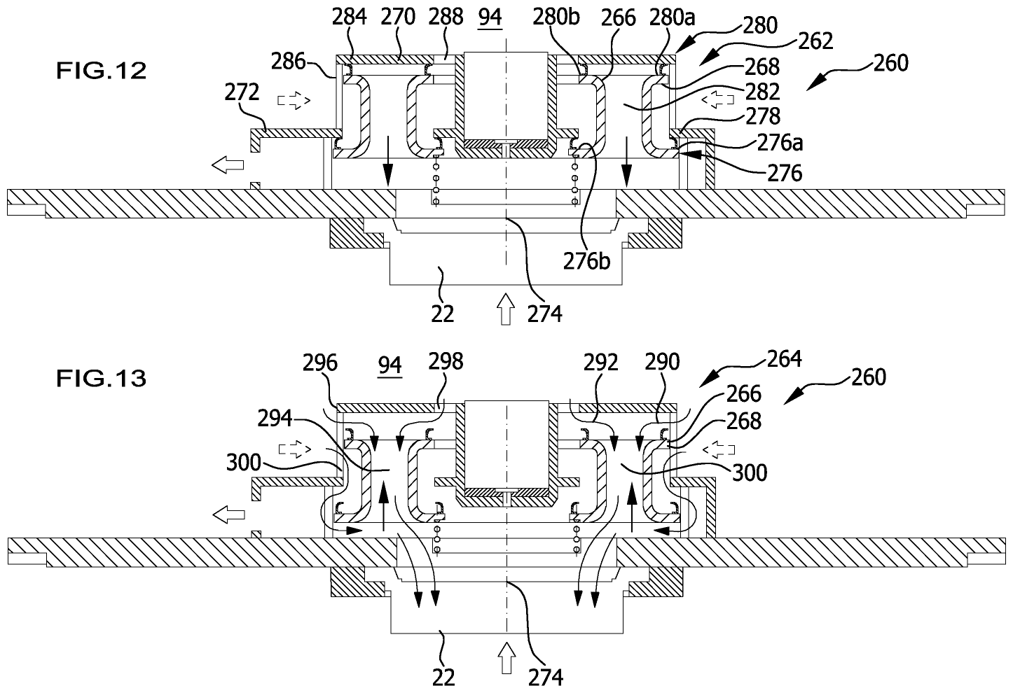

In a sixth embodiment of a filter cleaning device, illustrated in FIGS. 12 and 13 and designated therein by the reference numeral 260, wherein FIG. 12 shows a closed position 262 and FIG. 13 shows an open position 264 of a valve 266, a closing body 268 is located at the valve 266. The closing body 268 is guided inside a housing 270 of a counter device 272. Here, the closing body 268 is displaceable in a height direction 274.

The closing body 268 has a first contact region 276 against a first wall 278 of the counter device 272. The first contact region 276 has a first sub-contact region 276a and a second sub-contact region 276b. The first sub-contact region 276a and the second sub-contact region 276b are in spaced-apart relation to one another in a radial direction perpendicular to the height direction 274. In particular, they are annular and are concentric to one another. In particular, the first sub-contact region 276a is an outer region which encloses the second sub-contact region 276b all around continuously.

Furthermore, a second contact region 280 is formed at the closing body 268, in spaced-apart relation to the first contact region 276 in the height direction. The second contact region 280 has a first sub-contact region 280a and a second sub-contact region 280b.

In particular, the sub-contact regions 280a and 280b are annular and are concentric to one another.

The sub-contact regions 280a, 280b are radially spaced-apart from one another, i.e., they are in spaced-apart relation to one another in a direction perpendicular to the height direction 274.

The counter device 272 has corresponding counter contact regions.

Formed in the closing body 268, between the first sub-contact region 276a and the second sub-contact region 276b of the first contact region 276 on the one hand and the first sub-contact region 280a and the second sub-contact region 280b of the second contact region 280, is a continuous and in particular annular opening 282. This forms part of a channel.

The second contact region 280 serves to make contact against a second wall 284 of the counter device 272 when in the closed position 262.

A lateral opening 286 is formed between the second wall 284 and the first wall 278.

Further, an annular opening 288, associated with the second sub-contact region 280b, is formed at the second wall 284.

At a stroke of the valve 266 from the open position 264 (cf. FIG. 13), flushing air from a normal pressure region 94 can flow in via the opening 286 and thereby flow through the opening 282 of the closing body 268. Furthermore, flushing air can flow in via the opening 286 and flow through the opening 282 of the closing body 268.

A first partial flow 290 and a second partial flow 292 form above the closing body 268 (cf. FIG. 13). A first channel 294 is formed which has a first inlet 296 and a second inlet 298.

Furthermore, a second channel 300 is formed, which channel generally corresponds to the second channel 124 in the filter cleaning device 34.

The first channel 294 is of T-shaped configuration in the area of the second wall 284, having a transverse area at which the first inlet 296 and the second inlet 298 are located.

The transverse area of the first channel 294 between the first inlet 296 and the second inlet 298 has a collection region 300. In the collection region 300, the first partial flow 290 and the second partial flow 292 are merged and flow out through the opening 282. In particular, the collection region 300 is located above the opening 282. Downstream of the collection region 300, a combined flow as a combination of the first partial flow 290 and the second partial flow 292 flows through the opening 282 in the closing body 268.

When the valve 266 is opened, the first partial flow 290 can then flow radially inwards starting from the first inlet 296 and then flow through the closing body 268. The second partial flow 292, which enters through the second inlet 298, can flow radially outwards and then flow through the opening 282 and thereby through the closing body 268 to the filter 22,

Otherwise, the filter cleaning device 260 works in the same manner as does the filter cleaning device 34.

In accordance with the invention, a filter cleaning device is provided which, when in the closed position, has contact regions (sealing regions) at different levels.

When a corresponding valve is opened, flushing air (external air) for filter cleaning can flow in from a normal pressure region at different levels. Separate partial flows can be combined, and these will then act upon the filter 22 for effective cleaning thereof.

This results in large radial cross-sections for incoming flushing air. The corresponding closing body has partial flows of flushing air flowing both therethrough and therearound.

This provides a way of achieving a volume of flushing air for filter cleaning which reaches a high level in respect of amount of filter cleaning air within a short time period. The corresponding valve can be quickly opened.

A filter cleaning device in accordance with the invention can find application in a stand-alone vacuum cleaner as described above. It can also find utilization, for example, in a suction apparatus which is integrated in a vehicle, such as in a self-propelled floor cleaning machine (which may be, for example, a sweeping machine 10). It can also find use in a suction robot, for example.

### LIST OF REFERENCE CHARACTERS

10 vacuum cleaner
12 suctioned material container
14 suction head
16 suction unit
18 port
20 suction hose
22 filter
24 dirty side
26 clean side
27 envelope
28 filter cleaning device
30 control device
32 battery device
34 filter cleaning device (first exemplary embodiment)
36 negative pressure chamber
38 opening
40 suction flow
42 valve
44 closing body
46 spindle
48 height direction
50 first guide device
52 second guide device
54 first disk element
56 second disk element
58 connection region
60 axis of symmetry
62 end face
64 end face
66 outer contour
68 space
70 first contact region
72 second contact region
74 counter device
76 housing
78 first wall
80 first counter contact region
82 first sealing device
84 second wall
85 first space
86 second counter contact region
87 further wall
88 second sealing device
89 second space
90 closed position
92 negative pressure region
94 normal pressure region
96 distance
98 opening
100 normal for a mouth opening
101 space
102 magnet device
104 magnet
106 armature
108 open position
110 stop
112 direction
114 direction
116 spring device
118 opening
120 sealing collar
122 first channel
124 second channel
126 first region
128 region of directional change
130 second region
132 first region
134 region of directional change
136 further first region
138 further second region
140 first partial flow
142 opening
144 second partial flow
146 filter cleaning flow
148 course
150 course
152 level
154 energy storage spring
156 filter cleaning device (second exemplary embodiment)
158 closing body
160 first disk element
162 second disk element
164 connection region
165 closed position
166 valve
168 direction
170 holding device
172 magnet device
174 holding magnet
176 spindle
178 holding plate
180 open position
182 filter cleaning device (third exemplary embodiment)
184 counter device
186 housing
188 closing body
190 first disk element
192 first contact region
194 second disk element
196 second contact region
198 connection region
200 first wall
202 second wall
204 height direction
206 third wall
207 first space
208 space
209 second space
210 valve
212 closed position
214 direction
216 first channel
218 second channel
220 open position
222 first region
224 further partial flow
226 filter cleaning device (fourth exemplary embodiment)
228 valve
230 closing body
232 second contact region
234 first contact region
236 filter cleaning device (fifth exemplary embodiment)
238 open position
240 valve
242 closing body
244 manual actuation element
246 spindle
248 first guide device
250 second guide device
252 counter device
254 direction
256 spring device
258 spring device
260 filter cleaning device (sixth exemplary embodiment)
262 closed position
264 open position
266 valve
268 closing body
270 housing
272 counter device
274 height direction
276 first contact region
276a first sub-contact region
276b second sub-contact region
278 first wall
280 second contact region
280a first sub-contact region
280b second sub-contact region
282 opening
284 second wall
286 lateral opening
288 opening
290 first partial flow
292 second partial flow
294 first channel
296 first inlet
298 second inlet
300 collection region

1. A suction apparatus, comprising:
a suction unit for creating a suction flow;
at least one filter; and
a filter cleaning device;
wherein the filter cleaning device comprises at least one valve having a movable closing body and a counter device for the closing body;
wherein in an open position of the at least one valve the at least one filter has a filter cleaning flow applied thereto;
wherein in a closed position of the at least one valve the filter cleaning flow is or becomes inactive;
wherein the closing body has at least a first contact region with the counter device and a second contact region with the counter device;
wherein the second contact region is in spaced-apart relation to the first contact region in a height direction;
wherein, in the closed position of the at least one valve, both the first contact region and the second contact region are in contact against the counter device;
wherein in the open position of the at least one valve, both the first contact region and the second contact region are in spaced-apart relation to the counter device; and
wherein, in the open position of the at least one valve, a flushing air flow flows past both the first contact region and the second contact region to the at least one filter.

2. The suction apparatus in accordance with claim 1, wherein a negative pressure region is provided in a suction mode of operation, at which negative pressure region the at least one filter is arranged, and a normal pressure region is provided, at which normal pressure region the counter device is arranged, wherein in the closed position of the at least one valve the normal pressure region is in fluid-tight isolation from the negative pressure region, and in the open position of the at least one valve the normal pressure region and the negative pressure region are operatively connected for fluid communication with each other by a channel device.

3. The suction apparatus in accordance with claim 2, wherein the filter cleaning flow is created or becomes created by bringing the at least one valve from the closed position to the open position.

4. The suction apparatus in accordance with claim 2, wherein the channel device at its input side opens to the normal pressure region and at its output side opens to the negative pressure region.

5. The suction apparatus in accordance with claim 2, wherein an inlet cross-section for air into the channel device increases continuously with valve stroke when the closing body is unseated from the counter device.

6. The suction apparatus in accordance with claim 1, wherein the filter cleaning flow is created or becomes created while the at least one filter has a suction flow applied thereto by the suction unit.

7. The suction apparatus in accordance with claim 1, wherein at least one of the following conditions is satisfied:
the height direction is parallel to a direction of movement of the closing body;
the height direction is parallel to a principal direction of flow of a suction flow when the latter flows through the at least one filter in a suction mode of operation;
the height direction is parallel to a principal direction of flow of the filter cleaning flow when the latter flows through the at least one filter;
the height direction is transverse to an envelope surface of the at least one filter at a clean side thereof;
the height direction is parallel to an axis of symmetry of the at least one valve.

8. The suction apparatus in accordance with claim 1, wherein the counter device has a first counter contact region for the first contact region and has a second counter contact region for the second contact region, wherein the second counter contact region and the first counter contact region are in spaced-apart relation in the height direction.

9. The suction apparatus in accordance with claim 1, wherein the first contact region and the second contact region in each case are associated with a sealing device.

10. The suction apparatus in accordance with claim 9, wherein at least one of the following conditions is satisfied:
the sealing device is arranged at the closing body;
the sealing device is arranged at the counter device.

11. The suction apparatus in accordance with claim 1, wherein the counter device comprises a housing in which the closing body is movably arranged and which has a throughflow space for flushing air.

12. The suction apparatus in accordance with claim 1, wherein a clean side of the at least one filter is located at a negative pressure chamber.

13. The suction apparatus in accordance with claim 11, with at least one of the following:
the negative pressure chamber is connected to the suction unit;
in a suction mode operation of the suction apparatus, the negative pressure chamber is permanently and operatively connected to the suction unit for fluid communication therewith;
at least one channel of the filter cleaning device opens to the negative pressure chamber for supplying air to the at least one filter when in a filter cleaning mode of operation;
the counter device is arranged at the negative pressure chamber;
the at least one valve provides fluid-tight isolation of the negative pressure chamber from a normal pressure region when the at least one valve is in a closed position.

14. The suction apparatus in accordance with claim 1, wherein at least one of the at least one valve and the closing body are of rotationally symmetric configuration relative to an axis of symmetry.

15. The suction apparatus in accordance with claim 1, wherein the closing body and the counter device are configured to conform to one another such that, in the open position of the at least one valve, a plurality of separate partial air flows flow at the filter cleaning device.

16. The suction apparatus in accordance with claim 1, wherein the filter cleaning device, in the open position of the at least one valve, has at least a first channel for a first partial flow and a second channel for a second partial flow, wherein the second channel is separate from the first channel.

17. The suction apparatus in accordance with claim 16, wherein at least one of the following conditions is satisfied:
the first channel at its input side opens to a normal pressure region;
the second channel at its input side opens to the normal pressure region;
the first channel at its output side opens to a negative pressure region;
the second channel at its output side opens to the negative pressure region;
the first channel at its input side is closed to the normal pressure region when the at least one valve is in the closed position;
the first channel at its input side is open to the normal pressure region when the at least one valve is in the open position;
the first channel at its output side is in permanent operative connection to the negative pressure region for fluid communication therewith;
the second channel at its output side is closed to the negative pressure region when the at least one valve is in the closed position;
the second channel at its output side is open to the negative pressure region when the at least one valve is in the open position;
the second channel at its input side is in permanent operative connection to the normal pressure region for fluid communication therewith.

18. The suction apparatus in accordance with claim 17, wherein the first channel, in at least a portion thereof, extends through the closing body.

19. The suction apparatus in accordance with claim 17, wherein at least one of the first channel and the second channel, in at least portions thereof, extend along a lateral outer contour of the closing body.

20. The suction apparatus in accordance with claim 17, wherein at least one of the first channel and the second channel have at least one first region and at least one second region, wherein the at least one first region is oriented transversely to the height direction and the at least one second region is oriented at least approximately parallel to the height direction and wherein, in a filter cleaning mode of operation, a principal direction of flow in the at least one first region is oriented transversely to the height direction, and wherein in the at least one second region, a principal direction of flow in the filter cleaning mode of operation is oriented at least approximately parallel to the height direction.

21. The suction apparatus in accordance with claim 20, wherein at least one of the first channel and the second channel have a region of directional change for changing a direction of flow.

22. The suction apparatus in accordance with claim 20, wherein at least one of the following conditions is satisfied:
at least one inlet of the first channel is arranged at a first region of the first channel;
at least one outlet of the first channel is arranged at a second region of the first channel;
at least one inlet of the second channel is arranged at a first region of the second channel;
at least one outlet of the second channel is arranged at a second region of the second channel.

23. The suction apparatus in accordance with claim 20, wherein at least one of the second channel and the first channel have first regions spaced-apart in the height direction and with a second region interposed therebetween.

24. The suction apparatus in accordance with claim 20, wherein at least one of the following conditions is satisfied:
in the open position of the at least one valve, a first region of the first channel is formed between a top side of the closing body and the counter device;
a second region of the first channel is formed in the closing body;
in the open position of the at least one valve, at least one of (i) one or more first regions of at least one of the second channel and the first channel, and (ii) one or more second regions of at least one of the second channel and the first channel are formed between the counter device and the closing body;
in the open position of the at least one valve, a first region of the second channel is formed between a bottom side of the closing body and the counter device.

25. The suction apparatus in accordance with claim 16, wherein at least one of the following conditions is satisfied:
the first channel has at least a first inlet and a second inlet spaced-apart from the first inlet;
the first channel is T-shaped in cross-section in at least a portion thereof;
the first channel has a transverse region at which the first inlet and the second inlet are arranged, wherein arranged at the transverse region is a collection region and wherein starting from the first inlet a first partial flow flows to the collection region and wherein starting from the second inlet a second partial flow flows to the collection region;
the first channel has a collection region which combines partial flows, and a combined flow is passed through the closing body to the at least one filter.

26. The suction apparatus in accordance with claim 1, wherein at least one of the first contact region and the second contact region have a plurality of sub-contact regions.

27. The suction apparatus in accordance with claim 1, with at least one of the following:
sub-contact regions of the associated first contact region are at the same height with respect to the height direction;
sub-contact regions of the second contact region are at the same height with respect to the height direction;
a first sub-contact region surrounds a second sub-contact region;
sub-contact regions are concentric to one another;
a channel passes through the closing body, between sub-contact regions.

28. The suction apparatus in accordance with claim 1, wherein the closing body comprises a first disk element and a second disk element which is in spaced-apart relationship to the first disk element in the height direction, wherein the first contact region is arranged or formed at the first disk element and the second contact region is arranged or formed at the second disk element, and wherein a connection region is positioned between the first disk element and the second disk element.

29. The suction apparatus in accordance with claim 28, wherein an outer contour of the connection region is set back in relation to a lateral end of the first disk element and the second disk element.

30. The suction apparatus in accordance with claim 29, wherein the closing body is C-shaped or U-shaped in cross-section at the connection region thereof.

31. The suction apparatus in accordance with claim 30, wherein the counter device comprises a wall which projects into a space between the first disk element and the second disk element.

32. The suction apparatus in accordance with claim 28, wherein the first contact region and the second contact region point in the same direction, relative to the height direction.

33. The suction apparatus in accordance with claim 28, wherein the first contact region at the first disk element points in a direction away from the at least one filter and the second contact region at the second disk element points in a direction away from the at least one filter, or wherein the first contact region at the first disk element points in a direction towards the at least one filter and the second contact region at the second disk element points in a direction towards the at least one filter.

34. The suction apparatus in accordance with claim 28, wherein the first disk element and the second disk element have different diameters.

35. The suction apparatus in accordance with claim 1, wherein the counter device and the closing body are configured to conform to each other such that when the at least one valve transitions from the closed position to the open position, the closing body moves in a direction of the at least one filter.

36. The suction apparatus in accordance with claim 1, wherein the counter device and the closing body are configured to conform to each other such that when the at least one valve transitions from the closed position to the open position, the closing body moves away from the at least one filter.

37. The suction apparatus in accordance with claim 1, wherein the counter device has a first wall as a counter face for the first contact region and has a second wall, spaced apart in the height direction, as a counter face for the second contact region.

38. The suction apparatus in accordance with claim 37, wherein an opening is arranged at the counter device, between the first wall and the second wall, which opening is operatively connected to a normal pressure region for fluid communication therewith.

39. The suction apparatus in accordance with claim 37, wherein the closing body, at a first disk element thereof and at a spaced-apart second disk element thereof, in each case, engages over the first wall.

40. The suction apparatus in accordance with claim 37, wherein the second contact region is movable between the first wall and the second wall.

41. The suction apparatus in accordance with claim 40, wherein a first space is formed between the second wall and the first wall, in which space a second disk element of the closing body is movable, and a second space is formed between the first wall and a further wall, in which space a first disk element of the closing body is movable.

42. The suction apparatus in accordance with claim 37, wherein the first contact region is movable between the first wall and the second wall.

43. The suction apparatus in accordance with claim 42, wherein a first space is formed between the second wall and a further wall, in which space a second disk element of the closing body is movable, and wherein a second space is formed between the first wall and the second wall, in which space a first disk element of the closing body is movable.

44. The suction apparatus in accordance with claim 1, wherein the filter cleaning device comprises a magnet device.

45. The suction apparatus in accordance with claim 44, wherein the magnet device comprises a switchable lifting solenoid, and wherein an armature is connected to the closing body, wherein the closing body can be driven in its movement via coupling the armature to the lifting solenoid.

46. The suction apparatus in accordance with claim 44, wherein the magnet device comprises a switchable holding magnet and is connected to the closing body at a counter element for the holding magnet.

47. The suction apparatus in accordance with claim 1, wherein a spring device is provided whose spring force seeks to bring the at least one valve from the open position to the closed position.

48. The suction apparatus in accordance with claim 1, wherein a manual actuation element is provided, which manual actuation element is connected to the closing body and serves to manually actuate a filter cleaning process.

49. The suction apparatus in accordance with claim 1, wherein an elastic energy storage device is associated with at least one of the at least one valve and an actuation element.

50. The suction apparatus in accordance with claim 1, wherein pressure-effective areas for the first contact region and the second contact region differ from one another.

51. The suction apparatus in accordance with claim 50, wherein the pressure-effective areas are configured to conform to one another such that, in operation of the suction apparatus, the at least one valve is in the closed position as a result of a pressure difference at the pressure-effective areas.

52. The suction apparatus in accordance with claim 50, wherein the pressure-effective areas are configured to conform to one another such that a force need be exerted on the closing body for it to transition from the closed position to the open position.

53. The suction apparatus in accordance with claim 50, wherein the pressure-effective areas are configured to conform to one another such that, in operation of the suction apparatus, an external holding force is necessary to hold the at least one valve in the closed position.

54. The suction apparatus in accordance with claim 53, wherein, when the holding force ceases to exist, a pressure difference brings the at least one valve from the closed position to the open position.

55. The suction apparatus in accordance with claim 1, wherein a battery device is provided for battery operation.

56. A method for cleaning a filter, in which method, by unseating a closing body of a valve from a counter device, the filter is acted upon by a filter cleaning air flow, wherein at least one of the following is performed: (i) in an open position of the valve, flushing air flows laterally past the closing body and flows through the closing body to the at least one filter, and (ii) in the open position of the valve, flushing air is incoupled at a plurality of regions spaced apart from one another in a height direction.

57. The method in accordance with claim 56, wherein, in a closed position of the valve, the closing body is in contact against the counter device at a first contact region and at a second contact region that are spaced apart in a height direction, and wherein, in the open position of the valve, flushing air flows past both the first contact region and the second contact region to the filter.

58. A suction apparatus, comprising:
a suction unit for creating a suction flow;
at least one filter; and
a filter cleaning device;
wherein the filter cleaning device comprises at least one valve having a movable closing body and a counter device for the closing body;
wherein in an open position of the at least one valve the at least one filter has a filter cleaning flow applied thereto;
wherein in a closed position of the at least one valve the filter cleaning flow is or becomes inactive; and
wherein the closing body and the counter device are configured to conform to one another such that, in the open position of the at least one valve, a plurality of separate partial air flows flow at the filter cleaning device.

59. The suction apparatus according to claim 58, wherein a first partial flow flows externally past the closing body and a second partial flow flows through the closing body, to the at least one filter.

60. A suction apparatus, comprising:
a suction unit for creating a suction flow;
at least one filter; and
a filter cleaning device;
wherein the filter cleaning device comprises at least one valve having a movable closing body and a counter device for the closing body;
wherein in an open position of the at least one valve the at least one filter has a filter cleaning flow applied thereto;
wherein in a closed position of the at least one valve the filter cleaning flow is or becomes inactive; and
wherein the filter cleaning device, in the open position of the at least one valve, has at least a first channel for a first partial flow and a second channel for a second partial flow, wherein the second channel is separate from the first channel.
